(19) United States
(12) Patent Application Publication
(10) Pub. No.: US 2009/0167754 A1
(43) Pub. Date: Jul. 2, 2009

(54) ELECTROPHORETIC DISPLAY CONTROL DEVICE, ELECTROPHORETIC DISPLAY DEVICE, AND COMPUTER-READABLE MEDIUM STORING PROGRAM OF CONTROLLING REDRAWING OF IMAGE OF ELECTROPHORETIC DISPLAY PANEL

(75) Inventor: Fumika Hatta, Kuwana-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 12/402,338

(22) Filed: Mar. 11, 2009

Related U.S. Application Data
(63) Continuation-in-part of application No. PCT/JP2007/064758, filed on Jul. 27, 2007.

(30) Foreign Application Priority Data
Sep. 27, 2006 (JP) 2006-263544

(51) Int. Cl. G09G 5/00; G09G 3/34

(52) U.S. Cl. 345/214

(57) ABSTRACT

An electrophoretic display control device controls redrawing of an image of an electrophoretic display panel. The electrophoretic display control device includes a source pulse generation device that generates a source pulse for each of pixels, an area determination device that determines whether a specific area is a first area or a second area, a gate pulse generation device that generates a first gate pulse or a second gate pulse in accordance with the specific area determined as the first area or the second area by the area determination device, a source pulse application device that applies the source pulse generated by the source pulse generation device to a source line, and a gate pulse application device that applies the first gate pulse or the second gate pulse generated by the gate pulse generation device to a gate line.

### CROSS-REFERENCE TO RELATED APPLICATION

This application is a continuation-in-part of International Application No. PCT/JP2007/064758, filed Jul. 27, 2007, which claims priority from Japanese Patent Application No. 2006-263544, filed on Sep. 27, 2006. The disclosure of the foregoing application is hereby incorporated by reference in its entirety.

### BACKGROUND OF THE INVENTION

The present disclosure relates to an electrophoretic display control device that controls an electrophoretic panel that utilizes the electrophoresis phenomenon to display an image, an electrophoretic display device that includes the electrophoretic display control device, and a computer-readable medium storing a program of controlling redrawing of an image of an electrophoretic display panel.

An electrophoretic display device is known that utilizes the electrophoresis phenomenon to display an image. In the electrophoretic display device, a sealed space is formed between a transparent display substrate and a rear substrate that is positioned such that the rear substrate faces the display substrate across an sealed space. A display portion is formed by filling the sealed space with a dispersion medium in which colored charged particles are dispersed. For example, charged particles that are dispersed in a liquid dispersion medium may include black charged particles, as well as white charged particles that have a different polarity from a polarity of the black particles. In this case, if the black charged particles are moved to the display substrate side of the sealed space by applying an electric field to the display portion, the color black is displayed by the display portion. Further, the color white can be displayed by applying an electric field in the opposite direction. Thus, a desired image can be produced by applying a combination of electric fields in both directions.

An electrophoretic display device that is driven by an active matrix method has been proposed as this sort of electrophoretic display device (refer, for example, to Japanese Laid-Open Patent Application No. 2002-116733). In the electrophoretic display device that uses the active matrix method, a plurality of active elements (for example, thin film transistors) that play the role of switches are arranged on the substrate in the form of a matrix. Gate lines and source lines that are respectively connected to the active elements are also provided in a grid pattern. The active elements are switched on and off by applying voltages to the gate lines and the source lines in a coordinated manner, thus making it possible to apply voltages to individual pixels that correspond to the individual active elements. Using the active matrix method to drive the electrophoretic display device may make it possible to display a sharp image without any irregularities.

An electrophoretic display device has also been proposed in which shaking pulses are applied to all of the pixels in the display portion, after which pulses are applied to move the charged particles (refer, for example, to Japanese Laid-Open Patent Application No. 2006-513440). The shaking pulses include pulses having alternating polarity. Moreover, the energy that the shaking pulses possess is sufficient to release the charged particles from a static state, but is not sufficient to cause the charged particles to move from one substrate to the other substrate. When the shaking pulses are applied to the pixels, the charged particles enter a state in which it is easy to put them into motion. Therefore, if the shaking pulses are applied, the charged particles can be moved quickly. Furthermore, because the effect of any display prior to the application of the shaking pulses can be reduced, it is possible to display a desired tone as it is in each pixel.

### SUMMARY OF THE INVENTION

When the image is redrawn in these sorts of known electrophoretic display devices, a current tone level of every pixel and a tone level to which the every pixel will be changed are determined. Further, to prevent deterioration of the image quality due to the passage of time, the shaking pulses are applied to every pixel, including a pixel of which the tone level will not change when the image is redrawn. After the shaking pulses are applied, pulses are applied to every pixel, with the waveforms of the pulses varying according to the relationship between the determined tone levels of each pixel before and after the redrawing of the image. Thus, the charged particles are moved, so that the image is redrawn. The processing to generate the pulses is therefore complex, so that considerable time may be required for the processing to redraw the image.

Various exemplary embodiments of the broad principles derived herein provide an electrophoretic display control device, an electrophoretic display device, and a computer-readable medium storing a program of controlling redrawing of an image of an electrophoretic display panel, in which the processing to generate the pulses is simplified and the processing to redraw the image may not require much time.

Exemplary embodiments provide an electrophoretic display control device that controls redrawing of an image of an electrophoretic display panel. The electrophoretic display panel includes a transparent display substrate, a rear substrate disposed to face the display substrate, a dispersion medium filled in a space between the display substrate and the rear substrate and having charged particles dispersed therein, pixel electrodes disposed in a matrix pattern on the rear substrate corresponding to pixels, a thin film transistor connected to each of the pixel electrodes, a gate line connected to the thin film transistor, and a source line connected to the thin film transistor. The electrophoretic display control device includes a source pulse generation device that generates a source pulse for each of the pixels, the source pulse being a pulse applied to the source line in accordance with a relationship between tone levels of each of the pixels before and after redrawing. The electrophoretic display control device also includes an area determination device that determines whether a specific area is a first area or a second area, the specific area being an area including pixels corresponding to the gate line, the first area being an area to which a first gate pulse is to be applied, the second area being an area to which a second gate pulse is to be applied, the first gate pulse being a pulse to be applied to the gate line and having a predetermined first waveform, and the second gate pulse to be applied to the gate line and having a second waveform different from the first waveform, and a gate pulse generation device that generates the first gate pulse or the second gate pulse in accordance with the specific area determined as the first area or the second area by the area determination device. The electrophoretic display control device further includes a source pulse application device that applies the source pulse generated by the source pulse generation device to the source line, and a gate pulse application device that applies the first gate pulse or the second gate pulse generated by the gate pulse generation device to the gate line.

Exemplary embodiments also provide an electrophoretic display device that includes an electrophoretic display panel and an electrophoretic display control device. The electrophoretic display panel includes a transparent display substrate, a rear substrate disposed to face the display substrate, a dispersion medium filled in a space between the display substrate and the rear substrate and having charged particles dispersed therein, pixel electrodes disposed in a matrix pattern on the rear substrate corresponding to pixels, a thin film transistor connected to each of the pixel electrodes, a gate line connected to the thin film transistor, and a source line connected to the thin film transistor. The electrophoretic display control device includes a source pulse generation device that generates a source pulse for each of the pixels, the source pulse being a pulse applied to the source line in accordance with a relationship between tone levels of each of the pixels before and after redrawing. The electrophoretic display control device also includes an area determination device that determines whether a specific area is a first area or a second area, the specific area being an area including pixels corresponding to the gate line, the first area being an area to which a first gate pulse is to be applied, the second area being an area to which a second gate pulse is to be applied, the first gate pulse being a pulse to be applied to the gate line and having a predetermined first waveform, and the second gate pulse to be applied to the gate line and having a second waveform different from the first waveform, and a gate pulse generation device that generates the first gate pulse or the second gate pulse in accordance with the specific area determined as the first area or the second area by the area determination device. The electrophoretic display control device further includes a source pulse application device that applies the source pulse generated by the source pulse generation device to the source line, and a gate pulse application device that applies the first gate pulse or the second gate pulse generated by the gate pulse generation device to the gate line.

Exemplary embodiments further provide a computer-readable medium storing a program of controlling redrawing of an image of an electrophoretic display panel. The electrophoretic display panel includes a transparent display substrate, a rear substrate disposed to face the display substrate, a dispersion medium filled in a space between the display substrate and the rear substrate and having charged particles dispersed therein, pixel electrodes disposed in a matrix pattern on the rear substrate corresponding to pixels, a thin film transistor connected to each of the pixel electrodes, a gate line connected to the thin film transistor, and a source line connected to the thin film transistor. The program includes instructions that cause a controller to perform the step of generating a source pulse for each of the pixels, the source pulse being a pulse applied to the source line in accordance with a relationship between tone levels of each of the pixels before and after redrawing. The program also includes instructions that cause a controller to perform the steps of determining whether a specific area is a first area or a second area, the specific area being an area including pixels corresponding to the gate line, the first area being an area to which a first gate pulse is to be applied, the second area being an area to which a second gate pulse is to be applied, the first gate pulse being a pulse to be applied to the gate line and having a predetermined first waveform, and the second gate pulse to be applied to the gate line and having a second waveform different from the first waveform, and generating the first gate pulse or the second gate pulse in accordance with the specific area determined as the first area or the second area. The program further includes instructions that cause a controller to perform the steps of applying the generated source pulse to the source line, and applying the generated first gate pulse or the generated second gate pulse to the gate line.

Other objects, features, and advantages of the present disclosure will be apparent to persons of ordinary skill in the art in view of the following detailed description of embodiments of the invention and the accompanying drawings.

### BRIEF DESCRIPTION OF THE DRAWINGS

Exemplary embodiments will be described below in detail with reference to the accompanying drawings in which:

FIG. 1 is a plan view of an electrophoretic display device;

FIG. 2 is a sectional view of a section I-I of a display panel as viewed from the direction of arrows shown in FIG. 1;

FIG. 3 is a block diagram that shows an electrical configuration of the electrophoretic display device;

FIG. 4 is a simplified sectional view of a structure of four display portions that have different tone levels;

FIG. 5 is a figure that shows waveforms of first pulses that are applied to pixel electrode in a case where black is changed to white;

FIG. 6 is a figure that shows waveforms of first pulses that are applied to the pixel electrode in a case where white is changed to light gray;

FIG. 7 is a figure that shows a connection relationship among gate lines, source lines, and the pixel electrodes;

FIG. 8 is a voltage control diagram that shows examples of waveforms of gate pulses that are applied to the gate lines, source pulses that are applied to the source lines, and the first pulses and second pulses that are applied to the pixel electrodes;

FIG. 9 is a figure that shows correspondence relationships between tone levels before and after a redrawing that makes the tone levels two levels lighter;

FIG. 10 is a figure that shows waveforms of the second pulses that are applied to the pixel electrodes in a case where an amount of change in tone level is 2;

FIG. 11 is a figure that shows correspondence relationships between tone levels before and after a redrawing that makes the tone levels one level darker;

FIG. 12 is a figure that shows waveforms of the second pulses that are applied to the pixel electrodes in a case where an amount of change in tone level is −1;

FIG. 13 is a figure that shows an example of a screen in which a menu is not displayed;

FIG. 14 is a figure that shows a state of a screen in a case where the menu is displayed in the screen that is shown in FIG. 13.

FIG. 15 is a flowchart of driver control processing that is performed in the electrophoretic display device;

FIG. 16 is a flowchart of gate pulse generation processing that is performed in the driver control processing;

FIG. 17 is a flowchart of source pulse generation processing that is performed in the driver control processing;

FIG. 18 is a flowchart of difference processing that is performed in the source pulse generation processing;

FIG. 19 is a flowchart of first source waveform processing that is performed in the difference processing;

FIG. 20 is a flowchart of second source waveform processing that is performed in the difference processing;

FIG. 21 is a flowchart of third source waveform processing that is performed in the difference processing;

FIG. 22 is a flowchart of fourth source waveform processing that is performed in the difference processing; and

FIG. 23 is a voltage control diagram that shows examples of waveforms of gate pulses that are applied to gate lines, source pulses that are applied to source lines, and first pulses and second pulses that are applied to pixel electrodes in an electrophoretic display device according to a modified embodiment.

### DETAILED DESCRIPTION OF THE EXEMPLARY EMBODIMENTS

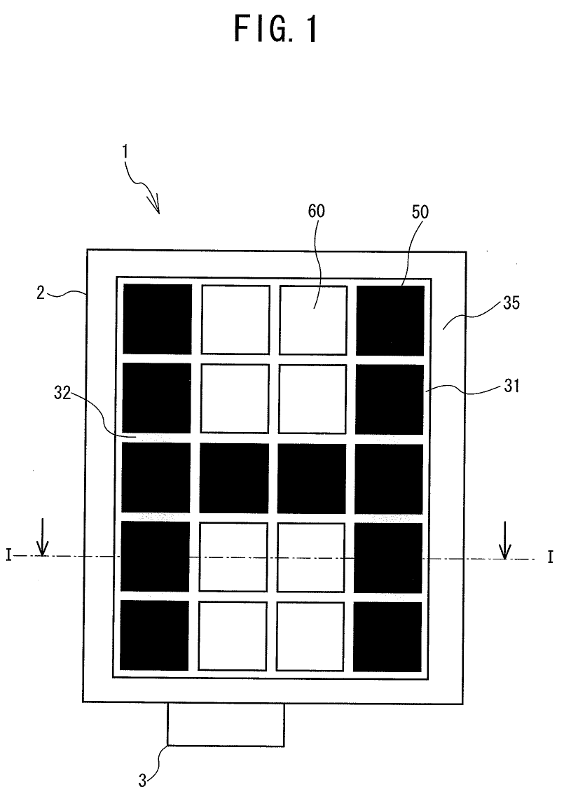

Embodiments of the present invention and their features and technical advantages may be understood by referring to FIGS. 1-23, like numerals being used for like corresponding portions in the various drawings.

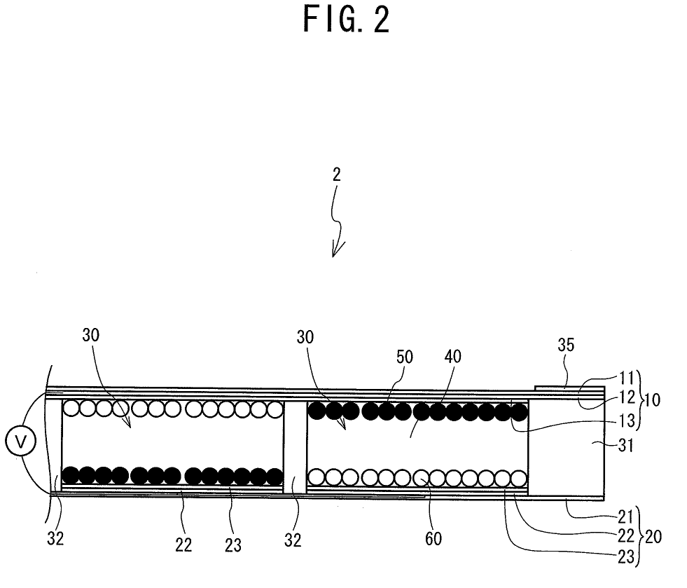

The following will describe an electrophoretic display device 1 that is an embodiment of an electrophoretic display device according to the present disclosure with reference to the drawings. In FIG. 2, a top side of the page is referred to as a top side of a display panel 2, and a bottom side of the page is a bottom side of the display panel 2. The display panel 2 according to the present embodiment may be installed in a portable electronic instrument, for example, and can display various types of images by being controlled and driven by a control device 3.

First, a configuration of the display panel 2 will be explained. As shown in FIG. 1, the electrophoretic display device 1 is configured such that the display panel 2 and the control device 3 are electrically connected, and the display panel 2 is formed in a rectangular shape in a plan view. As shown in FIG. 2, the display panel 2 includes a display substrate 10 that is provided substantially horizontally on the top side and a rear substrate 20 that is arranged substantially horizontally such that the rear substrate faces a bottom side of the display substrate 10 with a spacer 31 between the rear substrate 20 and the display substrate 10. A plurality of display portions 30 that are demarcated by a partition wall 32 are formed in a space that is sandwiched between the display substrate 10 and the rear substrate 20. Detailed structures of the various component parts will be explained in order below.

First, the structure of the display substrate 10 will be explained. As shown in FIG. 2, the display substrate 10 includes a display layer 11 that is formed from a transparent material and may serve as a display surface, a transparent common electrode 12 that is provided below the display layer 11 and may generate an electrical field in the display portions 30, and a protective layer 13 that is provided below the common electrode 12 and may protect the common electrode 12. The display layer 11 is formed from a material that is highly transparent and has strong insulation properties. For example, polyethylene naphthalate, polyether sulfone, polyimide, polyethylene terephthalate, glass, and the like may be used for the display layer 11. The common electrode 12 is formed from a material that is highly transparent and can be used as an electrode. For example, metal oxides such as indium tin oxide, fluorine-doped tin oxide, indium-doped zinc oxide, and the like may be used for the common electrode 12. In the present embodiment, the display layer 11 is a transparent glass substrate, the common electrode 12 is a transparent electrode that is formed from indium tin oxide, and the protective layer 13 is a plastic substrate (a resin film) that is formed from flexible polyethylene terephthalate.

Further, as shown in FIGS. 1 and 2, a mask portion 35 is provided on the upper surface of the display substrate 10 (the surface that does not face the rear substrate 20) to hide the outer edge portions of the display portions 30 such that a user cannot see the outer edge portions in a plan view. The mask portion 35 is a rectangular, sheet-like frame member that is provided with through-holes such that the user can see the display portions 30, and has a fixed width around the four sides of the display substrate 10. The mask portion 35 may be formed from a synthetic resin such as colored polyethylene terephthalate or the like and may also be formed from an ink layer or the like. Thus, when the user looks at the display panel 2 from above, the user can see, through the through-holes in the mask portion 35, a display area that includes the plurality of the display portions 30.

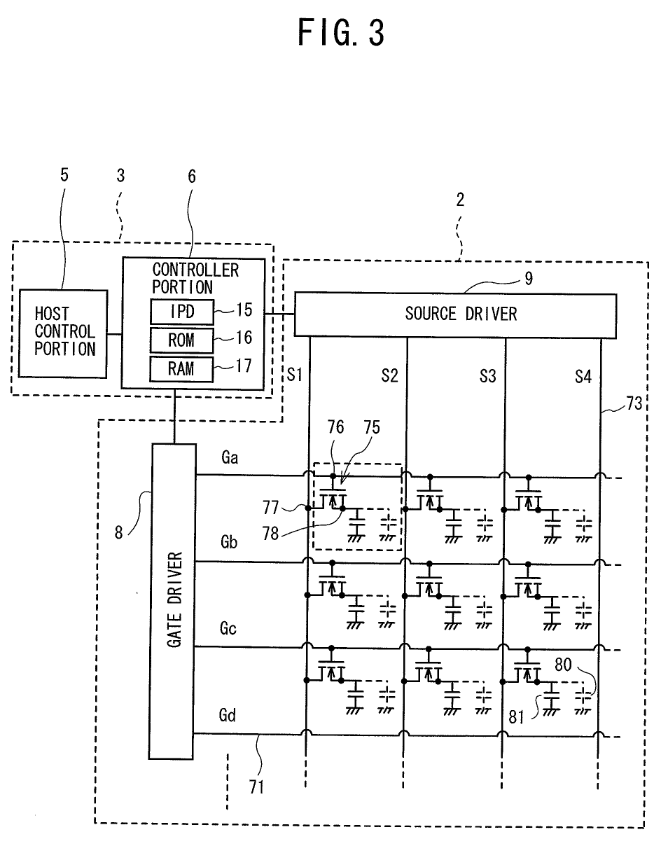

Next, the structure of the rear substrate 20 will be explained. As shown in FIG. 2, the rear substrate 20 includes a housing support layer 21 that supports the display panel 2, pixel electrodes 22, which are respectively provided for the display portions 30 on the top surface of the housing support layer 21 and may generate an electrical field in the respective display portion 30, and a protective layer 23 that is provided over the top surfaces of the pixel electrodes 22. A plurality of gate lines 71, source lines 73, and thin film transistors (hereinafter referred to as “TFTs”) 75 are integrated into the housing support layer 21 (refer to FIG. 3). Each of the TFTs 75, which function as switching elements, is connected to one of the demarcated pixel electrodes 22 and performs (on/off) control of the application of a voltage to the corresponding pixel electrode 22, details of which will be described later. A material that has strong insulation properties is used for the housing support layer 21. For example, an inorganic material such as glass, an insulation-treated metal film, or the like may be used for the housing support layer 21, and an organic material such as polyethylene terephthalate or the like may also be used. Each layer of the rear substrate 20 may be clear and may also be colored unlike the layers of the display substrate 10. In the present embodiment, the housing support layer 21 is a glass substrate, the pixel electrodes 22 are electrodes that are formed from indium tin oxide, and the protective layer 23 is a plastic substrate (a resin film) that is formed from flexible polyethylene terephthalate.

Next, the structure of the display portions 30 will be explained. As shown in FIG. 2, the spacer 31 is provided between the display substrate 10 and the rear substrate 20. The spacer 31 is a sheet-like frame member, rectangular in a plan view, is provided with a through-hole in the center of the spacer 31, and is formed from a flexible member. A sealed space is formed among the display substrate 10, the rear substrate 20, and the spacer 31. The sealed space is equally divided by the partition walls 32 into the plurality of the display portions 30, and the aforementioned pixel electrodes 22 are demarcated such that the pixel electrodes 22 respectively correspond to the display portions 30. A pixel is formed in the electrophoretic display device 1 for each of the demarcated pixel electrodes 22. A plurality of the pixels may be included in one of the display portions 30, and one pixel may also be included in a plurality of the display portions 30. The spacer 31 and the partition walls 32 may be formed as a single unit. The spacer 31 and the partition walls 32 may be formed from a light hardening resin. In the present embodiment, the spacer 31 and the partition walls 32 are formed integrally from an epoxy light hardening resin. A dispersion medium 40 with black charged particles 50 and white charged particles 60 dispersed therein is enclosed within the display portions 30 having the structures described above.

Next, the black charged particles 50, the white charged particles 60, and the dispersion medium 40 will be explained. An alcohol, a hydrocarbon, a silicone oil, or the like that has low viscosity and can exhibit strong insulation properties can be used as the dispersion medium 40. In the present embodiment, an insulating hydrocarbon solvent to which a small amount of alcohol has been added is used as the dispersion medium 40. The black charged particles 50 and the white charged particles 60 are formed from a material that is chargeable in the dispersion medium 40. The material may be, for example, one of a pigment that includes one of an organic compound and an inorganic compound, a dye that includes one of an organic compound and an inorganic compound, and a synthetic resin that contains one of a pigment and a dye. In the present embodiment, polymethyl methacrylate (PMMA) resin particles that include carbon black are used for the black charged particles 50, and polymethyl methacrylate (PMMA) resin particles that include titanium oxide are used for the white charged particles 60. The black charged particles 50 and the white charged particles 60 may be charged one of positively and negatively such that the black charged particles 50 and the white charged particles 60 are oppositely charged. In the present embodiment, the black charged particles 50 have a positive (plus) charge, and the white charged particles 60 have a negative (minus) charge.

Next, an electrical configuration of the electrophoretic display device 1 will be explained with reference to FIG. 3. As shown in FIG. 3, the electrophoretic display device 1 includes the display panel 2 and the control device 3.

The control device 3 includes a host control portion 5 and a controller portion 6. The host control portion 5 includes a CPU that performs the main control of the electrophoretic display device 1, a ROM that stores a control program and the like, a RAM that temporarily stores a flag, data, and the like, a memory card interface that is used for acquiring image data from a memory card, a timing generator that generates, in synchronization with the image data, a timing signal for controlling redrawing of an image, and the like, which are not shown in the drawings. The controller portion 6 includes an integrated passive device (hereinafter referred to as “IPD”) 15 for controlling a gate driver 8 and a source driver 9, a ROM 16, a RAM 17, and the like. In addition to performing overall control of the electrophoretic display device 1, the host control portion 5 transmits to the controller portion 6 an image redrawing command and the image data before and after the image is redrawn, notifies the controller portion 6 whether a menu will be displayed, which is described later, in the image after the image is redrawn, and the like. The controller portion 6 then performs control of the gate driver 8 and the source driver 9 based on the command, the data, and the like.

The display panel 2 includes the gate driver 8 and the source driver 9. The plurality of the gate lines 71 extend in parallel from the gate driver 8, and the plurality of the source lines 73 extend in parallel from the source driver 9. The gate lines 71 and the source lines 73 are arranged such that the gate lines 71 and the source lines 73 intersect, and one of the TFTs 75 is provided in the vicinity of each intersection portion. In each of the TFTs 75, a gate 76 is connected to the gate line 71, and a drain 77 is connected to the source line 73. Further, a source 78 in each of the TFTs 75 is connected to a pixel capacitor 80 and a storage capacitor 81. The pixel capacitor 80 is required between the common electrode 12 and the pixel electrode 22 due to the structure. The storage capacitor 81 is provided to increase a time constant for an operation of holding a voltage that is applied to the pixel electrode 22.

In the electrophoretic display device 1 that is configured in this manner, if an ON voltage is not applied to one of the gate lines 71, all of the TFTs 75 that are connected to the gate line 71 enter an off state. If the gate driver 8 applies an ON voltage to one of the gate lines 71, all of the TFTs 75 that are connected to the gate line 71 enter an on state. Thus control of the on and off states of the TFTs 75 is performed by controlling the voltage that is applied to the gate lines 71. Further, if the source driver 9 applies a positive voltage to one of the source lines 73 that is connected to one of the TFTs 75 that are in the on state, a positive voltage is applied to the pixel electrode 22 (refer to FIG. 2) that is connected to the TFT 75. If the source driver 9 applies a negative voltage to the source line 73, a negative voltage is applied to the pixel electrode 22 that is connected to the TFT 75. A power supply circuit (not shown in the drawings) also applies a voltage (for example, zero volt) that is common to the pixels to the common electrode layer 12 of the display substrate 10. Therefore, an electrical field is generated between the pixel electrodes 22 and the common electrode 12, and the black charged particles 50 and the white charged particles 60 may move. In this manner, the active matrix method can display an image by independently controlling the tone level of each pixel.

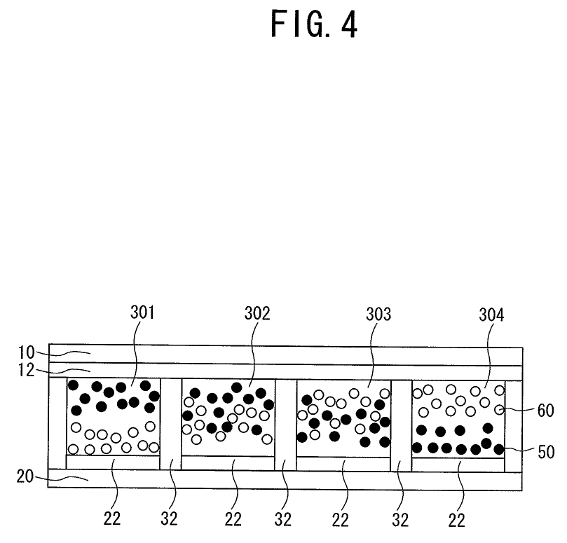

Next, the principle of a tone display will be explained with reference to FIG. 4. In the present embodiment, an image is displayed by using four tones of black, dark gray, light gray, and white. The tone levels are determined by the mean distributions of the black charged particles 50 and the white charged particles 60 within the display portions 30. As described above, the black charged particles 50 have positive charges, and the white charged particles 60 have negative charges. Accordingly, in a case where an electrical potential on the display substrate 10 side serves as a reference potential and a sufficient electric field is generated by making the rear substrate 20 side positive, the black charged particles 50 are distributed in the vicinity of the display substrate 10, and the white charged particles 60 are distributed in the vicinity of the rear substrate 20, as in a black display portion 301 that is shown in FIG. 4. At this time, black is displayed on the display substrate 10. In a case where the electrical potential on the display substrate 10 side serves as the reference potential and a sufficient electric field is generated by making the rear substrate 20 side negative, the black charged particles 50 are distributed in the vicinity of the rear substrate 20, and the white charged particles 60 are distributed in the vicinity of the display substrate 10, as in a white display portion 304 that is shown in FIG. 4. At this time, white is displayed on the display substrate 10.

In a case where the black charged particles 50 and the white charged particles 60 are positioned close to an intermediate position between the display substrate 10 and the rear substrate 20 by regulating one of the magnitude of the applied voltage and the time that the voltage is applied, both the black charged particles 50 and the white charged particles 60 can be seen from the display substrate 10 side, so the tone level becomes gray. In this case, in the present embodiment, dark gray and light gray can be respectively displayed by varying the distributions of the charged particles 50 and 60, as in a dark gray display portion 302 and a light gray display portion 303 that are shown in FIG. 4. Moreover, the dark gray tone and the light gray tone are set such that black is changed to dark gray, dark gray is changed to light gray, and light gray is changed to white by applying a voltage of a specified magnitude for a specified length of time. In a case where the tones are made darker, each of the changes in the tones, from white to light gray to dark gray to black, in that order, is made by applying the same amount of energy. The number of the tone levels that can be used to display an image is not limited to four, and the number may be varied as necessary.

Waveforms of pulses that are applied to the pixel electrodes 22 in the present embodiment will be explained below. In the present embodiment, a first area and a second area are distinguished. The first area is an area where the redrawing of the image is performed while maintaining the quality of the display. The second area is an area where the redrawing of the image is performed with low power consumption under a simple control in exchange for permitting a slight deterioration in the quality of the display. The pulses that are applied to the pixel electrodes 22 are classified into two types, first pulses that are applied to the pixel electrodes 22 in the first area and second pulses that are applied to the pixel electrodes 22 in the second area. In the present embodiment, in a case where the pulses are applied to the pixel electrodes 22, a voltage of zero volt is constantly applied to the common electrode 12 of the display substrate 10. Furthermore, as described above, the pulses are applied to the pixel electrodes 22 by the gate driver 8 and the source driver 9.

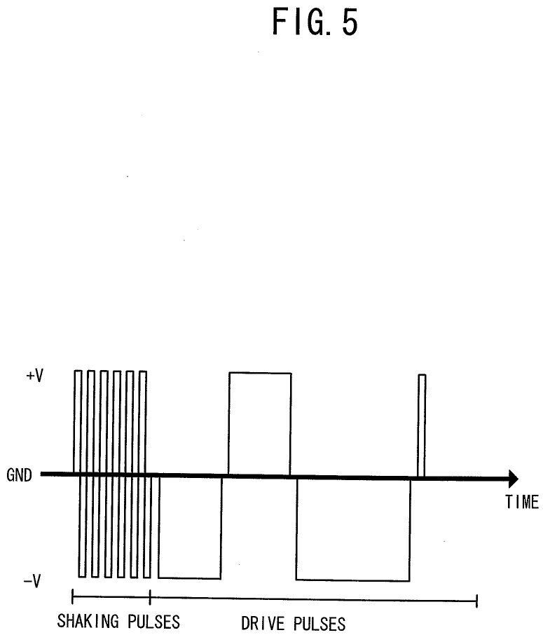

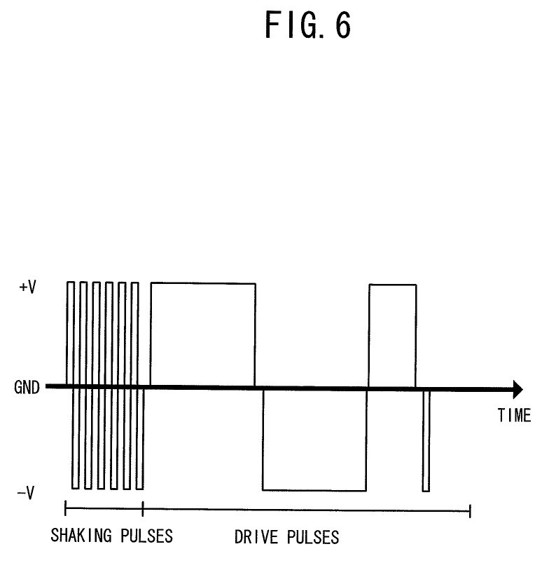

First, an example of the waveforms of the first pulses will be explained with reference to FIGS. 5 and 6.

As shown in FIG. 5, in a case where the first pulses are applied to change the display from black to white, the shaking pulses are applied first. The shaking pulses are pulses that have alternating polarity, and they have energy that is sufficient to release the charged particles 50 and 60 from a static state, but is not sufficient to cause the charged particles 50 and 60 to move from one substrate to the other substrate. If the shaking pulses pare applied to the pixel electrodes 22, the charged particles 50 and 60 that have adhered to the surfaces of the display substrate 10 and the rear substrate 20 are detached, and the charged particles 50 and 60 are released from the static state. Accordingly, when pulses are applied to move the charged particles 50 and 60 after the shaking pulses have been applied, it is possible to move the charged particles 50 and 60 more quickly than if the shaking pulses had not been applied. Furthermore, because the effect of any display prior to the application of the shaking pulses may be reduced, it may be possible to display a desired tone as it is in each pixel. In the present embodiment, in a case where the first pulses are applied, the shaking pulses with the same waveform are applied to all of the pixel electrodes 22, regardless of any changes in the tones before and after redawing.

Next, in order to move the charged particles 50 and 60, drive pulses are applied in accordance with the changes in the tones before and after redrawing. As described above, in the present embodiment, four tones of black, dark gray, light gray, and white, are used. Therefore, if the cases where the tone levels are the same before and after redrawing are included, the total number of the changes in the tone levels is sixteen. Therefore, there are sixteen types of waveforms for the drive pulses. As shown in FIG. 5, in a case where the drive pulses for changing the display from black to white are used, a negative voltage is applied first, such that the black charged particles 50 move to the rear substrate 20 side and the white charged particles 60 move to the display substrate 10 side. Next, a positive voltage is applied, such that the charged particles 50 and 60 move to the opposite sides. Accordingly, velocities of the charged particles 50 and 60 and distribution of the charged particles 50 and 60 in the direction parallel to the substrates become uniform (reset processing). Next, a negative voltage is applied again, such that the white charged particles 60 are moved to the display substrate 10 side and white is displayed. Then a positive voltage that damps the movement of the charged particles 50 and 60 is applied for a short time in order to make the particles stop in a short time (damping processing). Then the movement of the charged particles 50 and 60 is stopped by completely stopping the generation of the electrical field (stop processing).

As shown in FIG. 6, in a case where the first pulses are applied to change the display from white to light gray, first the shaking pulses are applied with the same waveforms as in the case shown in FIG. 5, such that the charged particles 50 and 60 are released from the static state. Next, a positive voltage is applied, such that the black charged particles 50 are moved to the display substrate 10 side and the white charged particles 60 are moved to the rear substrate 20 side. Then a negative voltage is applied, such that the white charged particles 60 are moved to the display substrate 10 side. Then a positive voltage is applied for a shorter length of time than when the charged particles 50 and 60 are moved between the substrates. Accordingly, a small amount of the black charged particles 50 are moved to the display substrate 10 side, and a small amount of the white charged particles 60 are disengaged from the display substrate 10 side, distributing the charged particles 50 and 60 in positions such that a light gray tone is displayed (refer to the light gray display portion 303 in FIG. 4). Next, a negative voltage that damps the movement of the charged particles 50 and 60 is applied for a short time. Then the movement of the charged particles 50 and 60 is stopped by completely stopping the generation of the electrical field.

Thus, in the case of the first pulses, the shaking pulses, which have the same waveforms irrespective of any changes in the tone levels before and after redrawing, are applied, after which one of the sixteen types of the drive pulses is applied according to the change in the tone level. With the passage of time, the black charged particles 50 and the white charged particles 60 that are contained in the dispersion medium 40 may be moved in the display portions 30 due to the effects of vibration, gravity, and the like. In such a case, the tone level in the display portions 30 is changed, so that the display quality of the image may be diminished. In order to prevent this sort of diminishing of the image quality with the passage of time, the first pulses are applied to the pixel electrodes 22 in the first area, even to a pixel electrode 22 in which there is no change in the tone level before and after redrawing, such as from black to black, dark gray to dark gray, and the like.

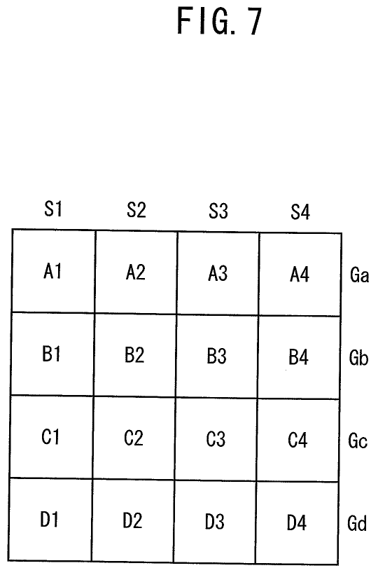

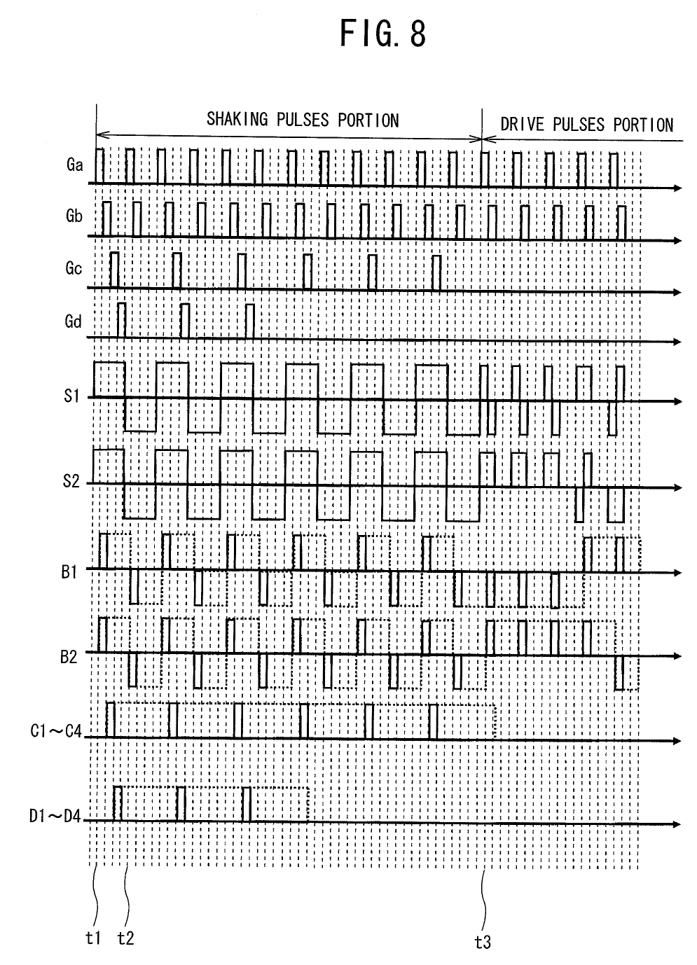

Next, waveforms of gate pulses that are applied to the gate lines 71 and waveforms of source pulses that are applied to the source lines 73 in a case where the first pulses are applied to the pixel electrodes 22 as described above will be explained with reference to FIGS. 7 and 8. The electrophoretic display device 1 has a large number of pixels, and large numbers of the pixel electrodes 22, the TFTs 75, the gate lines 71, and the source lines 73 are provided in accordance with the number of the pixels. However, in order to simplify the explanation, a case will be explained in which four each of the gate lines 71 and the source lines 73 are provided, and correspondingly, sixteen of the pixel electrodes 22 are provided. Further, in FIG. 8, the polarities of the voltages of the source pulses are positive on the upper side and negative on the lower side. The horizontal axis is a time axis. A time period from when an ON voltage starts to be applied to a gate line 71 until an ON voltage starts to be applied to a next gate line 71 is defined as 1P. The length of 1P is controlled by the timing signal that is generated by the timing generator of the host control portion 5 such that the length of 1P is constant.

As shown in FIG. 7, the four gate lines 71 that are arranged in parallel are respectively referred to as Ga, Gb, Gc, and Gd, and the four source lines 73 that intersect the gate lines 71 at right angles are respectively referred to as S1, S2, S3, and S4. In the explanation that follows, the pixel electrode 22 that corresponds to the TFT 75 that is connected to the gate line Ga and the source line S1 will be referred to as A1, and the pixel electrode 22 that corresponds to the TFT 75 that is connected to the gate line Gb and the source line S3 will be referred to as B3, for example. Further, in the current example, an area that includes all of the pixel electrodes 22 (A1 to A4 and B1 to B4) that are connected to the gate line Ga and the gate line Gb will be the first area to which the first pulses are applied. Additionally, an area that includes all of the pixel electrodes 22 (C1 to C4 and D1 to D4) that are connected to the gate line Gc and the gate line Gd will be the second area to which the second pulses are applied.

As shown in FIG. 8, first gate pulses (waveforms Ga and Gb) are applied to the gate lines Ga and Gb that correspond to the first area. The first gate pulses have a waveform by which ON voltages are applied in cycles of once in a period of 4P, which is obtained by multiplying 1P by the number (4) of the gate lines 71. In a case where the image is redrawn, shaking source pulses having alternating polarity (for example, the waveforms shown in the shaking pulses portion of S1 and S2) are first applied to all of the source lines 73, including the source line S1 and the source line S2, in order to apply the shaking pulses (for example, the waveforms shown in the shaking pulses portion of B1 and B2) to all of the pixel electrodes 22 in the first area. The shaking source pulses change their polarities every 4P, such that one cycle lasts 8P, and the shaking pulses are repeatedly applied for six cycles. Then drive source pulses (for example, the waveforms shown in the drive pulses portion of S1 and S2) are applied to all of the source lines 73. The drive source pulses are used to apply, to the pixel electrodes 22, drive pulses (for example, the waveforms shown in the drive pulses portion of B1 and B2) that correspond to the changes in the tones of the respective pixels.

The pixel electrode B1 in the first area will be focused on below. At timing t1, an ON voltage is applied to the gate line Gb, so the TFT 75 turns on. At this time, a positive voltage is being applied to the source line S1. Accordingly, at timing t1, a positive voltage is applied to the pixel electrode B1. Then, after one P has elapsed, the TFT 75 turns off. Because the storage capacitor 81 (refer to FIG. 3) is provided to accumulate a charge in the TFT 75, the voltage that is applied to the pixel electrode B1 is not damped abruptly, but diminishes gradually. Next, at timing t2, an ON voltage is once again applied to the gate line Gb, and the TFT 75 turns on. At this time, a negative voltage is being applied to the source line S1. Accordingly, at timing t2, a negative voltage is applied to the pixel electrode B1. The shaking pulses are applied to the pixel electrode B1 by repeating this operation six times.

Next, when the TFT 75 turns on at timing t3, a negative voltage is being applied to the source line S1. Negative voltages are also being applied to the source line S1 after 4P and 8P from the timing t3. Accordingly, negative drive pulses are applied to the pixel electrode B1 three times in a period of 12P. Thus, the first pulses are applied to the pixel electrodes 22 in the first area, such as B1 and B2, by regulating the timings at which the first gate pulses are applied to the gate lines Ga, Gb and the timing at which the source pulses are applied to the source lines S1 to S4.

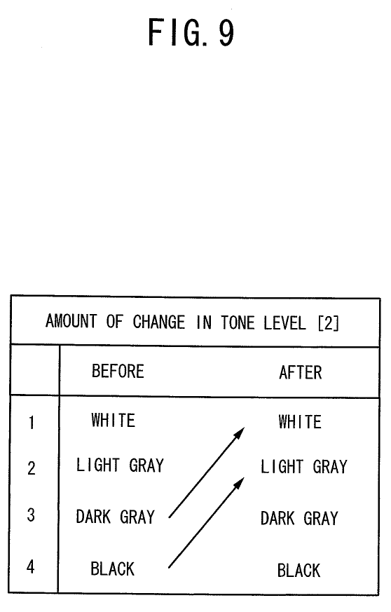

Next, the waveforms of the second pulses will be explained with reference to FIGS. 9 to 12.

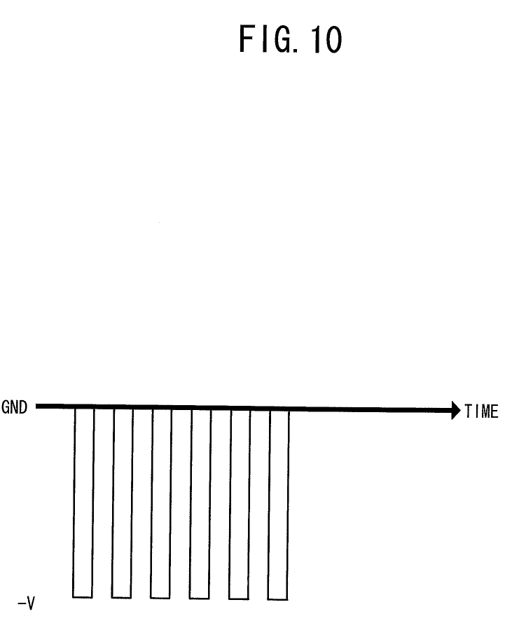

In the present embodiment, the first pulses, which include the shaking pulses that have a common waveform and the sixteen types of the drive pulses, are applied to the pixel electrodes 22 in the first area when the image is redrawn. In contrast, the second pulses, which are pulses that can be applied with lower power consumption than the first pulses and have simpler waveforms than the first pulses, are applied to the pixel electrodes 22 in the second area. In a case where the second pulses are applied, the amounts of change in the tone levels of the pixels are computed first. As described above, the minimum amount of energy that is required to make any one of the tone levels one tone lighter is the same for all of the tone levels. Therefore, as shown in FIG. 9, the amount of energy that is required to make any one of the tone levels two tones lighter is always the same. That is, the amount of energy that is required to change black to light gray is equal to the amount of energy that is required to change dark gray to white. The amount of change in the tone level in this case is 2, and in a case where the amount of change is defined as 2, a predetermined negative pulse is applied six times to the pixel electrodes 22, as shown in FIG. 10.

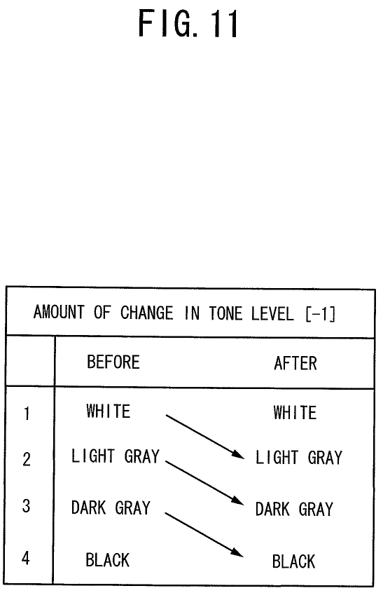

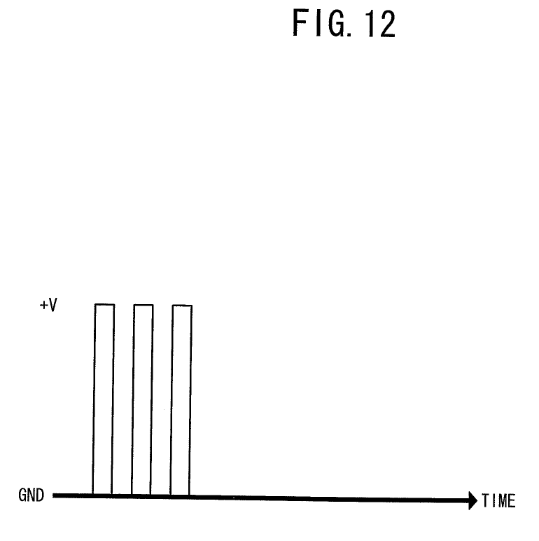

In the same manner, in a case where the pixels in the second area are made one tone darker, the amount of change is the same when white, light gray, and dark gray are respectively changed to light gray, dark gray, and black, as shown in FIG. 11. The amount of change in the tone level is defined as −1, and in a case where the amount of change is −1, a predetermined positive pulse is applied three times to the pixel electrodes 22, as shown in FIG. 12. In a case where a tone level of a pixel in the second area does not change from before to after redrawing, the amount of change is zero, and second pulses for which the voltage is constantly an OFF voltage (zero volt in the present embodiment) are applied to a pixel electrode 22 that correspond to the pixel. In a case where the amount of change is 1, a predetermined negative pulse is applied to the pixel electrode 22 three times, and in a case where the amount of change is −2, a predetermined positive pulse is applied to the pixel electrode 22 six times. Thus, the waveforms of the second pulses are classified into five types, 2, 1, 0, −1, and −2, according to the amount of change in the tone level. Thus, the second pulses that are applied to the pixel electrodes 22 in the second area are pulses that have simple waveforms and can be applied with lower power consumption, so that it may be possible to consume less power than when the first pulses are applied to all of the pixel electrodes 22. Furthermore, it may be easy to control the redrawing of the image.

Next, the waveforms of the gate pulses and the waveforms of the source pulses that are used to apply the second source pulses to the pixel electrodes 22 that are located in the second area will be explained with reference to FIG. 8. In a case where the redrawing of the image is performed, the shaking source pulses that includes pulses having alternating polarity are applied to all of the gate lines 73 in order to apply the shaking pulses to all of the pixels in the first area, as described above. Accordingly, while the shaking source pulses are used, the second gate pulses, which have a different waveform from the waveform of the first gate pulses, are applied to the gate lines 71. Thus, the second gate pulses, all having the same waveform, are applied to all of the pixel electrodes 22 that are connected to the same gate line 71.

The waveforms of the pulses will be explained specifically by focusing on the pixel electrodes C1 to C4 in the second area. In the following explanation, it is assumed that the amount of change in the tone level is −2 for each of the four pixels that correspond to the pixel electrodes C1 to C4. In this case, the waveform of the second gate pulses that are applied to the gate line Gc is generated such that only the positive voltage is applied six times to the pixel electrodes C1 to C4, using the shaking source pulses (the waveforms shown in the shaking pulses portion of S1 and S2) that include pulses for alternately applying the positive voltage and the negative voltage six times each. Specifically, instead of the cycles of the first gate pulses (the waveforms Ga and Gb), which are applied in cycles of once in a period of 4P, cycles of once in a period of 8P is employed. Further, while the positive shaking source pulses are being applied, the second gate pulses (−2) (the waveform Gc) are applied to the gate line Gc, such that an ON voltage is applied. Then, after the predetermined positive pulse has been applied six times to the pixel electrodes C1 to C4, the waveform of the second gate pulses (−2) applies an OFF voltage. Thus, without changing the waveforms of the shaking source pulses, the second gate pulses (−2) (the waveform Gc), for which the ON voltage is applied six times on a different cycle from the cycle of the first gate pulses, are applied to the gate line Gc. Accordingly, the second pulses (the waveforms C1 to C4 in FIG. 8) are applied to the four pixel electrodes C1 to C4 that are connected to the gate line Gc. This in turn causes the tone levels of the four pixels that correspond to the pixel electrodes C1 to C4 to become two tones darker.

It is assumed that the pixel electrodes D1 to D4 that are connected to the gate line Gd are located in the second area, and the amount of change in the tone level is −1 for each of the four corresponding pixels. In this case, the waveform of the second gate pulses (−1) (the waveform Gd) that are applied to the gate line Gd is generated such that only the positive voltage is applied three times to the pixel electrodes D1 to D4, using the shaking source pulses (the waveforms shown in the shaking pulses portion of S1 and S2). Then, after the predetermined positive pulse has been applied three times, the waveform of the second gate pulses (−1) applies an OFF voltage. Thus, the second gate pulses, all having the same waveform, are applied to the pixel electrodes D1 to D4 that are connected to the gate line Gd, causing the tone levels of the four pixels that correspond to the pixel electrodes D1 to D4 to become one tone darker.

In the second area, in a case where the amount of change in the tone level is 2 for all of the pixels that correspond to the same gate line 71, the second gate pulses (+2) are generated such that only the negative voltage is applied six times to the pixel electrodes 22, using the shaking source pulses. In the same manner, in the second area, in a case where the amount of change in the tone level is 1 for all of the pixels that correspond to the same gate line 71, the second gate pulses (+1) are generated such that only the negative voltage is applied three times to the pixel electrodes 22, using the shaking source pulses. Furthermore, in the second area, in a case where the tone level does not change for any of the pixels that correspond to the same gate line 71, that is, in a case where the amount of change is zero, the second gate pulses (±0) are generated such that the voltage is constantly off.

As explained above, the shaking source pulses, which are the source pulses that are used to apply the shaking pulses to the pixels in the first area, are also used in a case where the tone level in the second area is changed. Moreover, the tone level of the pixels in the second area may be changed by applying to the gate lines 71 the second gate pulses that correspond to the amount of the change. It is therefore not necessary to generate other shaking pulses in order to apply the second pulses to the pixels in the second area, so control of the redrawing of the image may be simplified. In addition, the second gate pulses that are applied to the gate lines 71 in the second area may be applied such that less power is consumed than when the first gate pulses are applied to the gate lines 71 in the first area.

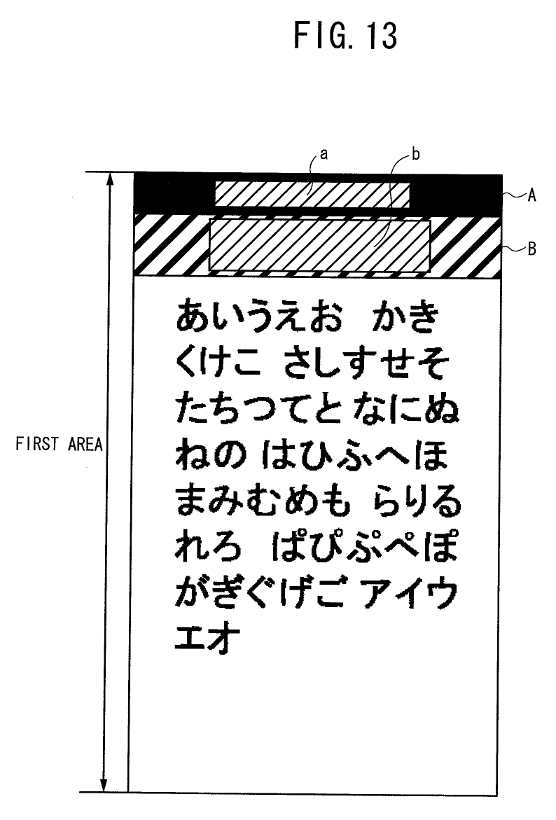

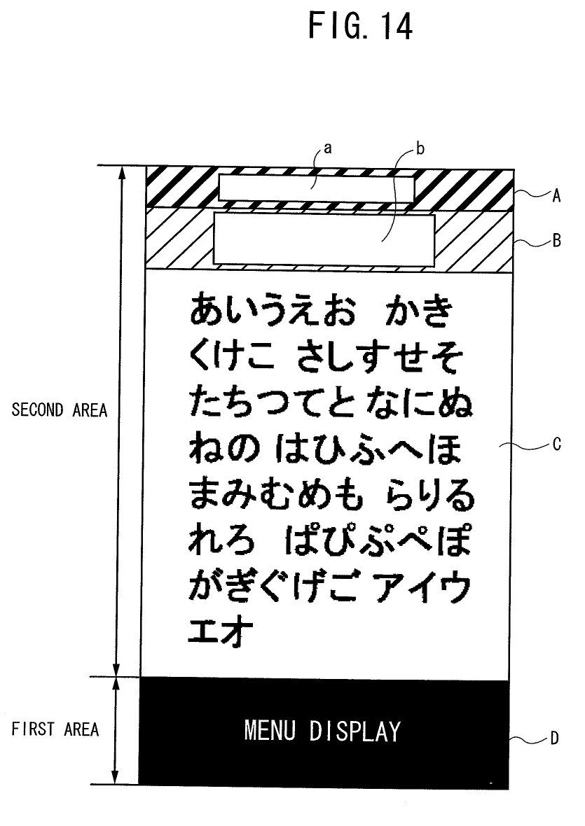

Next, the first area and the second area will be explained with reference to FIGS. 13 and 14. On the screens that are shown in FIGS. 13 and 14, a plurality of the gate lines 71 are arranged in the horizontal direction, and a plurality of the source lines 73 are arranged in the vertical direction.

In the present embodiment, the first area, in which the redrawing of the image is performed without diminishing the quality of the display, and the second area, in which the redrawing of the image is performed with low power consumption under a simple control in exchange for permitting a slight deterioration in the quality of the display, are distinguished. In addition, a different form of redrawing control is performed in each area. In a case where necessary information is displayed over the entire display area, as shown in FIG. 13, the appearance of the image may worsen and the image may be difficult to be recognized if the quality of the display is deteriorated. However, in a case where, for example, a menu such as an operation menu or the like is displayed in a portion of the display area, as shown in FIG. 14, the user may not look very much at the area outside an area for the menu during the time that the menu is being displayed. Accordingly, although it may be necessary to maintain the quality of the display in the area where the menu is displayed, few problems may be caused by a deterioration in the quality of the display in the area where the menu is not displayed. Conversely, the area where the menu is displayed may become more conspicuous than the other area.

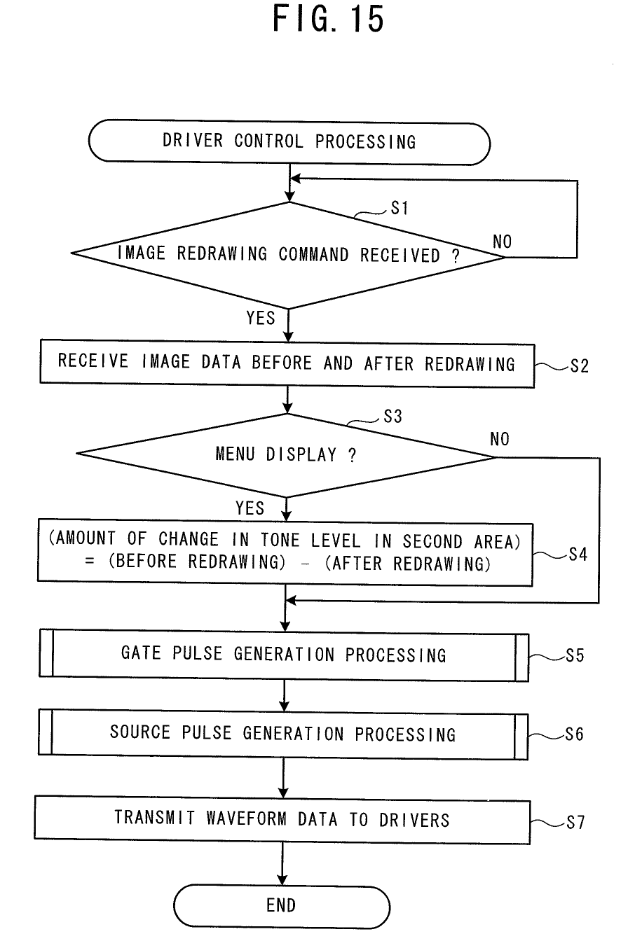

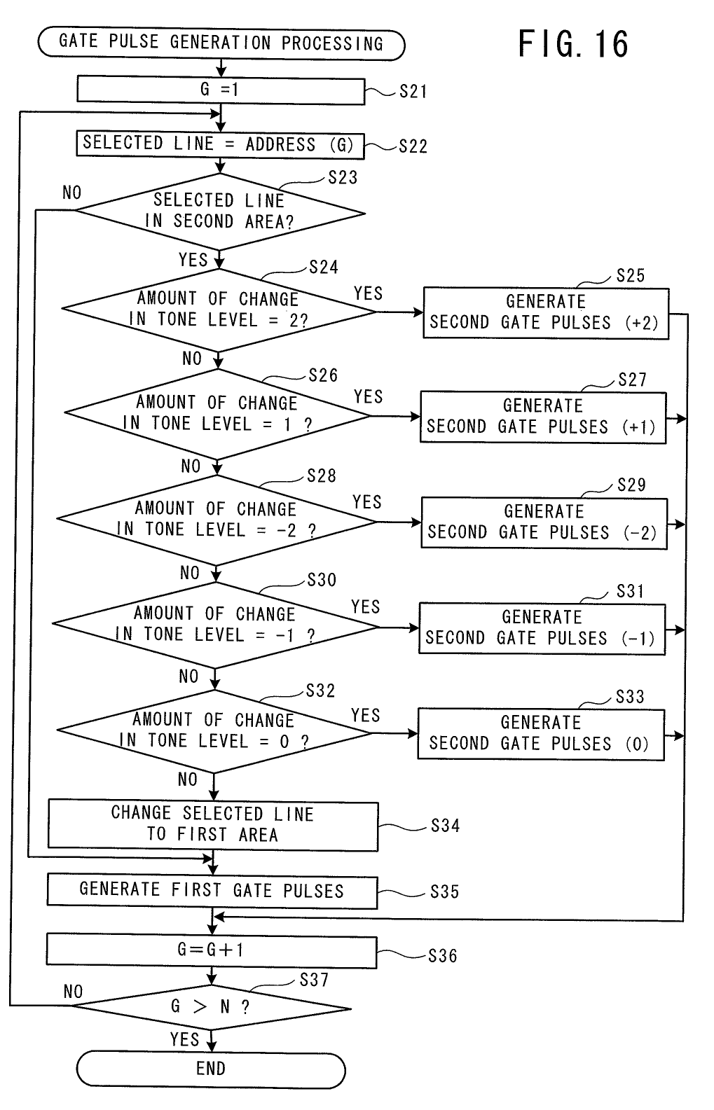

As described above, the second pulses with the same waveform may be applied to all of the pixels that correspond to the same gate line 71 by using the source pulses that are generated in order to apply the first pulses and changing the cycle of the gate pulse waveform. Control may thus be made simpler, and power consumption may be reduced. Therefore, in the present embodiment, in a case where the image is redrawn, it is first determined whether a menu is to be displayed after the image is redrawn. If a menu is not to be displayed (refer to FIG. 13), the quality of the display may be maintained for all of the pixels, so the entire screen may be treated as the first area. On the other hand, if a menu is to be displayed (refer to FIG. 14), areas each including a plurality of pixels that correspond to the same gate line 71 are defined as specific areas, and it is determined whether each of the specific areas is the first area or the second area. A specific area that does not include any pixels that are used to form an image of a menu display and in which the amount of change in the tone level is the same for all of the pixels is defined as a second area. Any specific area that is not a second area defined as a first area. The image is then redrawn. A method of determining whether a specific area is a first area or a second area will be explained below with reference to flowcharts that are shown in FIGS. 15 and 16.

Next, the first area and the second area will be explained using a specific example. In a case where, as shown in FIGS. 13 and 14, an image in an area “A,” for example, is redrawn such that black is changed to dark gray, and light gray is changed to white in an area “a,” the amount of change in the tone levels is 1 in both areas. In other words, there are no pixels in the area “A” for which the amounts of change in the tone levels are different. In the same manner, in a case where, in an area “B,” dark gray is changed to light gray, and light gray is changed to white in an area “b,” the amount of change in the tone levels is 1 for all of the pixels in the area “B.” In an area “C” (refer to FIG. 14), there are no pixels for which the tone levels are to be changed from before to after redrawing. Furthermore, after the image is redrawn, no menu display image is to be formed in any one of the areas “A,” “B,” and “C.” Accordingly, in a case where the image that is shown in FIG. 13 is redrawn to the image that is shown in FIG. 14, the second pulses are applied the area “A,” “B,” and “C,” which are treated as the second areas. In addition, the first pulses are applied to an area “D” (refer to FIG. 14), which is an area where a menu is displayed and is treated as the first area.

Next, details of the image redrawing operation by the electrophoretic display device 1 according to the present embodiment will be explained with reference to flowcharts in FIGS. 15 to 22. The letter S will hereinafter stand for “step” for each step in the flowcharts. The processing that is explained below is performed by the IPD 15, which is provided in the controller portion 6, based on a control program that is stored in the ROM 16.

First, driver control processing will be explained with reference to FIG. 15. The driver control processing is started in the controller portion 6 when the power supply to the electrophoretic display device 1 is turned on. In the driver control processing, a determination is first made as to whether an image redrawing command has been received from the host control portion 5 (S1), and while the command has not been received (NO at S1), the determination is repeated. When it is determined that the redrawing command has been received (YES at S1), the IPD 15 receives, from the host control portion 5, image data for both before and after the redrawing. The received image data is stored in the RAM 17 in the controller portion 6 (S2).

Next, a determination is made as to whether a menu is to be displayed in the image after the image is redrawn (S3). Data that indicates whether a menu is to be displayed is included in the image data that is transmitted from the host control portion 5. The determination at S3 is made according to the data that indicates whether a menu is to be displayed. If it is determined that a menu is to be displayed in the image after the image is redrawn (YES at S3), a specific area where the image of the menu display is to be formed is defined as the first area, and a specific area where the image of the menu display is not to be formed are defined as the second area. Next, the amount of change in the tone level is computed for each of the specific areas in the second area (S4). After the computation result is stored in the RAM 17 in the controller portion 6, gate pulse generation processing is performed (S5). In some cases, even an area that has been defined as a second area and for which the amount of change in the tone level has been computed may be changed to the first area, although details will be explained below with reference to FIG. 16. On the other hand, if it is determined that a menu is not to be displayed in the image after the image is redrawn (NO at S3), all of the specific areas are defined as first areas in order to maintain the quality of the display in all of the pixels. The gate pulse generation processing is then performed without computing the amount of change in the tone levels of the pixels in the specific areas (S5).

Next, the gate pulse generation processing will be explained with reference to FIG. 16. In the gate pulse generation processing, a determination is made for each specific area as to whether the specific area is a first area or a second area. If the specific area is the second area, a determination is made as to what the value of the computed amount of change in the tone level is. Then the gate pulses that are applied to the gate line 71 are generated in accordance with the result of the determination.

In the gate pulse generation processing, first, a counter G is initialized to an initial value of 1 (S21). The value of the counter G indicates what number of a gate line 71 is to be processed among N gate lines 71. Next, the gate line 71 that, among the N gate lines 71, is indicated by the value of the counter G is designated as a selected line (S22). Next, a determination is made as to whether the specific area that corresponds to the designated selected line is a second area (S23). If the specific area that corresponds to the selected line is not a second area (NO at S23), the specific area that corresponds to the selected line is a first area, so the first gate pulses are generated as the gate pulses to be applied to the selected line (S35). Then, 1 is added to the value of the counter G (S36).

If the specific area that corresponds to the selected line is a second area (YES at S23), a determination is made as to whether the amount of change in the tone levels is 2 (S24). The amount of change in the tone levels is computed in the processing at S4, shown in FIG. 15, and is stored in the RAM 17 of the controller portion 6. If the amount of change in the tone levels is 2 (YES at S24), in order to apply the second gate pulses for making the tone levels two tones lighter (refer to FIG. 10) to all of the pixel electrodes 22 in the specific area, the second gate pulses (+2) are generated as the gate pulses to be applied to the selected line (S25). The processing then proceeds to S36.

If the amount of change in the tone levels is not 2 (NO at S24), a determination is made as to whether the amount of change in the tone levels is 1 (S26). If the amount of change in the tone levels is 1 (YES at S26), in order to apply the second gate pulses for making the tone levels one tone lighter to all of the pixel electrodes 22 in the specific area, the second gate pulses (+1) are generated as the gate pulses to be applied to the selected line (S27). The processing then proceeds to S36.

If the amount of change in the tone levels is not 1 (NO at S26), a determination is made as to whether the amount of change in the tone levels is −2 (S28). If the amount of change in the tone levels is −2 (YES at S28), in order to apply the second gate pulses for making the tone levels two tones darker to all of the pixel electrodes 22 in the specific area, the second gate pulses (−2) are generated as the gate pulses to be applied to the selected line (S29). The processing then proceeds to S36.

If the amount of change in the tone levels is not −2 (NO at S28), a determination is made as to whether the amount of change in the tone levels is −1 (S30). If the amount of change in the tone levels is −1 (YES at S30), in order to apply the second gate pulses for making the tone levels one tone darker (refer to FIG. 12) to all of the pixel electrodes 22 in the specific area, the second gate pulses (−1) are generated as the gate pulses to be applied to the selected line (S31). The processing then proceeds to S36.

If the amount of change in the tone levels is not −1 (NO at S30), a determination is made as to whether the amount of change in the tone levels is zero (S32). If the amount of change in the tone levels is zero (YES at S32), the ON voltage is not applied to the pixel electrodes 22 in the specific area, so the second gate pulses (±0) to constantly apply the OFF voltage are generated (S33). The processing then proceeds to S36.

If the amount of change in the tone levels is not zero (NO at S32), the pixels that correspond to the currently selected line include a pixel with a different amount of change in the tone level. As described above, in the present embodiment, the same second pulses are applied to all of the pixels in the specific area by applying to the source lines the shaking source pulses generated to apply the first pulses and applying to the gate lines the second gate pulses that correspond to the amount of change in the tone level. Therefore, if the specific area includes a pixel with a different amount of change in the tone levels, the image is redrawn by applying first pulses corresponding to the respective pixels in the specific area. Accordingly, the specific area that corresponds to the currently selected line is changed to a first area (S34), and the first gate pulses are generated as the gate pulses to be applied to the selected line (S35). The processing then proceeds to S36.

Next, 1 is added to the value of the counter G (S36), and a determination is made as to whether the value of the counter G is not greater than the number N of the gate lines 71 (S37). If the value of the counter G is not greater than N (NO at S37), a gate line 71 still remains for which the gate pulses have not been generated, so the processing returns to S22. On the other hand, if the value of the counter G is greater than N (YES at S37), the generation of the gate pulses has been completed for all of the gate lines 71, so the gate pulse generation processing ends, and the processing returns to the driver control processing. As shown in FIG. 15, in the driver control processing, when the gate pulse generation processing (S5) ends, source pulse generation processing is performed (S6).

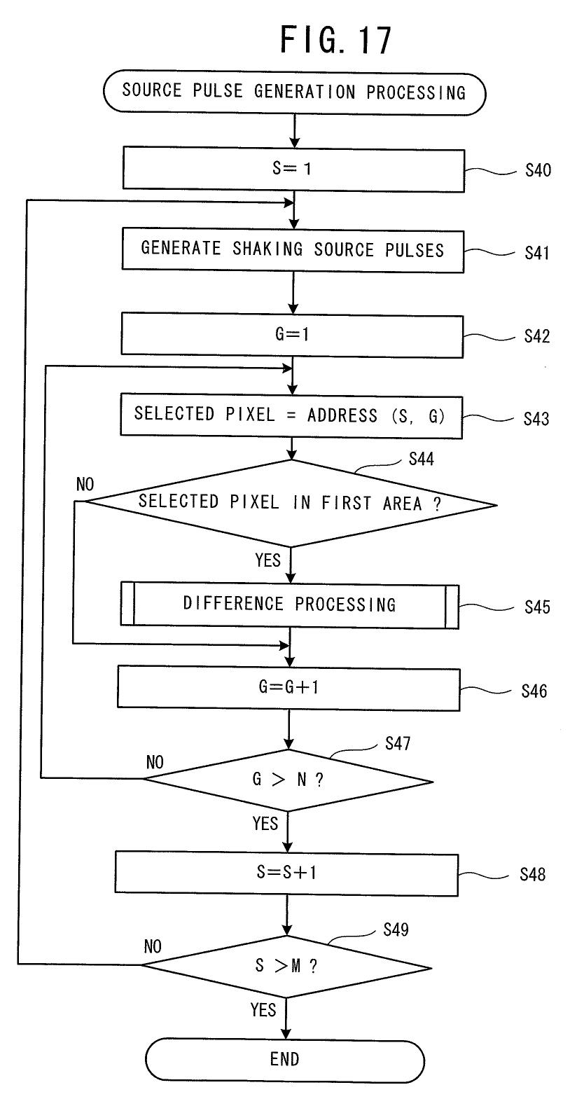

Next, the source pulse generation processing will be explained with reference to FIG. 17. In the source pulse generation processing, a determination is made for each of the pixel electrodes 22 as to whether the pixel electrode 22 is in a first area or in a second area. If the pixel is in the first area, difference processing is performed, and one of the sixteen types of the source pulses is generated in accordance with the amount of change in the tone level of the pixel from before to after the image is redrawn.

In the source pulse generation processing, first, a counter S is initialized to an initial value of 1 (S40). The value of the counter S indicates what number of a source line 73 is to be processed among M source lines 73. Next, shaking source pulses that include pulses having alternating polarity are generated as the source pulses that are applied at the start to all of the source lines 73 (S41). In a first area, the shaking source pulses allow the shaking pulses to be applied to the pixel electrodes 22. In a second area, the shaking source pulsed allow the tone levels in the specific area to be collectively changed. Next, the value of the counter G, which indicates what number of a gate line 71 is to be processed among the N gate lines 71, is initialized to an initial value of 1 (S42). Next, one of the provided M×N pixels that is indicated by the value of the counter S and the value of the counter G is designated as a selected pixel (S43).

Next, a determination is made as to whether the designated selected pixel is a pixel in the first area (S44). As described above, one of the sixteen types of the first pulses is generated for the pixel electrode 22 that corresponds to the pixel in the first area, in accordance with the relationships between the tone levels of the pixel before and after the image is redrawn. In contrast, for the pixel electrode 22 that corresponds to the pixel in the second area, the second pulses are generated, for which the voltage is constantly an OFF voltage after the pulses are applied with the shaking source pulses. Therefore, if the selected pixel is a pixel in the second area (NO at S44), 1 is added to the value of the counter G (S46) without generating new source pulses to be applied after the shaking source pulses. If the selected pixel is a pixel in the first area (YES at S44), the difference processing is performed (S45).

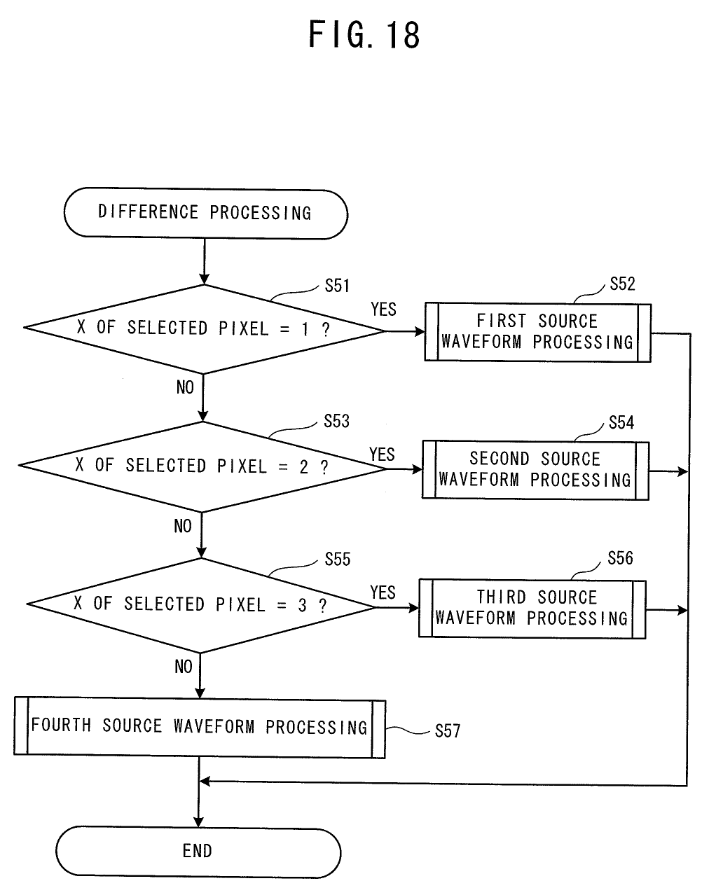

Next, the difference processing will be explained with reference to FIGS. 18 to 22. In the difference processing, processing is performed to generate the drive source pulses that are the source pulses used to apply the drive pulses (refer to FIGS. 5 and 6, for example) to the pixel electrode 22 in the first area. Hereinafter, the tone level of the selected pixel before the image is redrawn is referred to as X, and the tone level of the selected pixel after the image is redrawn is referred to as Y. Further, a value is assigned to each of the four types of tone levels, such that white is 1, light gray is 2, dark gray is 3, and black is 4.

As shown in FIG. 18, when the difference processing is started, first, a determination is made as to whether the tone level X of the selected pixel before redrawing is white (1) (S51). In a case where the image is redrawn, the image data for both before and after the redrawing is transmitted from the host control portion 5 to the controller portion 6, and is then stored in the RAM 17 of the controller portion 6. The determination as to whether the tone level X of the selected pixel before redrawing is white (1) is made by referring to the image data before redrawing that is stored in the RAM 17. If the tone level X of the selected pixel before redrawing is white (1) (YES at S51), first source waveform processing is performed (S 52).

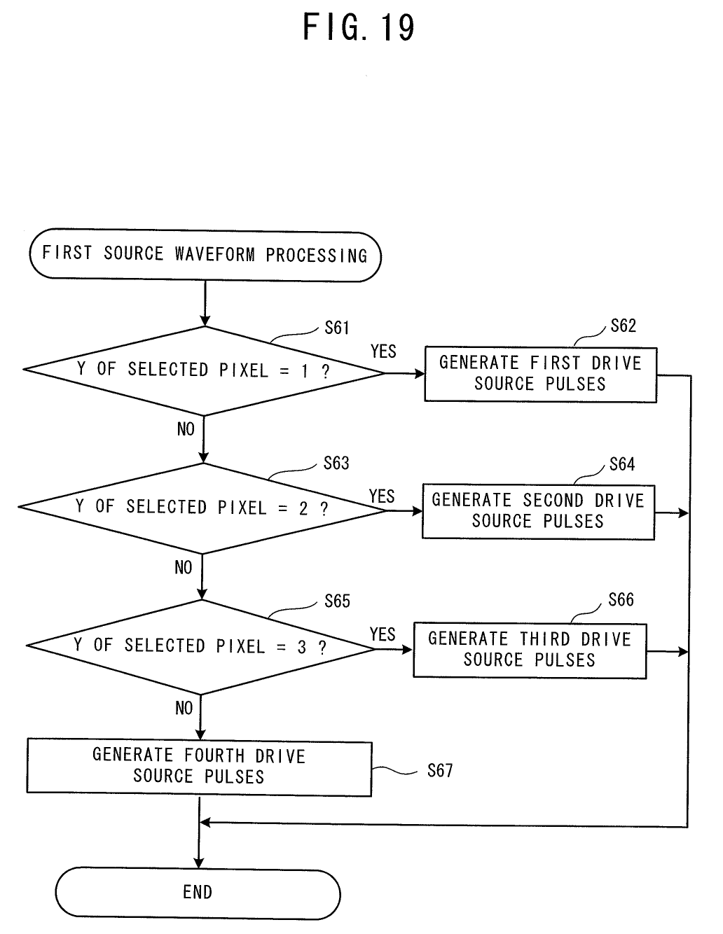

As shown in FIG. 19, in the first source waveform processing, a determination is made as to whether the tone level Y of the selected pixel after redrawing is white (1) (S61). The determination is made by referring to the image data after redrawing that is stored in the RAM 17 of the controller portion 6. If the tone level Y after redrawing is white (1) (YES at S61), first drive source pulses for redrawing from white to white, are generated as the drive source pulses that is applied to the pixel electrode 22 that corresponds to the selected pixel (S62). The first source waveform processing then ends. In this case, as explained above, in order to prevent deterioration in the quality of the display in the first area due to the passage of time, the first pulses for moving the charged particles 50 and 60 are applied even to the pixel electrode 22 for the pixel the tone level of which is not to be changed from before to after the image is redrawn. Therefore, in the first drive source pulses, a predetermined ON voltage is applied, unlike the second pulses in which a voltage is constantly an OFF voltage after the shaking pulses have been applied.

If the tone level Y after redrawing is not white (1) (NO at S61), a determination is made as to whether the tone level Y after redrawing is light gray (2) (S63). If the tone level is light gray (2) (YES at S63), second drive source pulses for redrawing from white to light gray, are generated (S64), and the first source waveform processing ends. If the tone level Y after redrawing is not light gray (2) (NO at S63), a determination is made as to whether the tone level Y after redrawing is dark gray (3) (S65). If the tone level is dark gray (3) (YES at S65), third drive source pulses for redrawing from white to dark gray, are generated (S66), and the first source waveform processing ends. If the tone level Y after redrawing is not dark gray (3) (NO at S65), fourth drive source pulses for redrawing from white to black, are generated (S67), and the first source waveform processing ends. When the source waveform 1 processing ends, the difference processing shown in FIG. 18 ends, and the processing returns to the source pulse generation processing shown in FIG. 17.

Next, returning to the explanation of the difference processing shown in FIG. 18, if it is determined that the tone level X of the selected pixel before redrawing is not white (1) (NO at S51), a determination is made as to whether the tone level X before redrawing is light gray (2) (S53). If the tone level X before redrawing is light gray (2) (YES at S53), second source waveform processing is performed (S54).

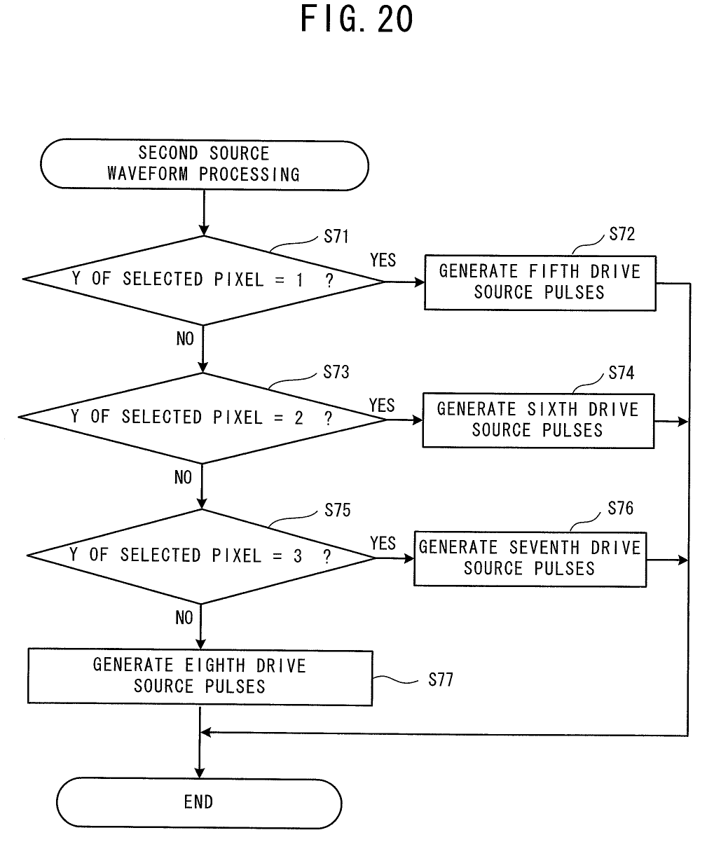

As shown in FIG. 20, in the second source waveform processing, in the same manner as in the first source waveform processing, first, a determination is made as to whether the tone level Y of the selected pixel after redrawing is white (1) (S71). If the tone level is white (1) (YES at S71), fifth drive source pulses for redrawing from light gray to white, are generated (S72), and the second source waveform processing ends. If the tone level Y after redrawing is not white (1) (NO at S71), a determination is made as to whether the tone level Y after redrawing is light gray (2) (S73). If the tone level is light gray (2) (YES at S73), source sixth drive pulses for redrawing from light gray to light gray, are generated (S74), and the second source waveform processing ends. If the tone level Y after redrawing is not light gray (2) (NO at S73), a determination is made as to whether the tone level Y after redrawing is dark gray (3) (S75). If the tone level is dark gray (3) (YES at S75), seventh drive source pulses for redrawing from light gray to dark gray, are generated (S76), and the second source waveform processing ends. If the tone level Y after redrawing is not dark gray (3) (NO at S75), eighth drive source pulses for redrawing from light gray to black, are generated (S77), and the second source waveform processing ends. When the second source waveform processing ends, the difference processing shown in FIG. 18 ends, and the processing returns to the source pulse generation processing shown in FIG. 17.

Next, returning to the explanation of the difference processing shown in FIG. 18, if it is determined that the tone level X of the selected pixel before redrawing is not white (1) (NO at S51) and not light gray (2) (NO at S53), a determination is made as to whether the tone level X before redrawing is dark gray (3) (S55). If the tone level X before redrawing is dark gray (3) (YES at S55), third source waveform processing is performed (S56).

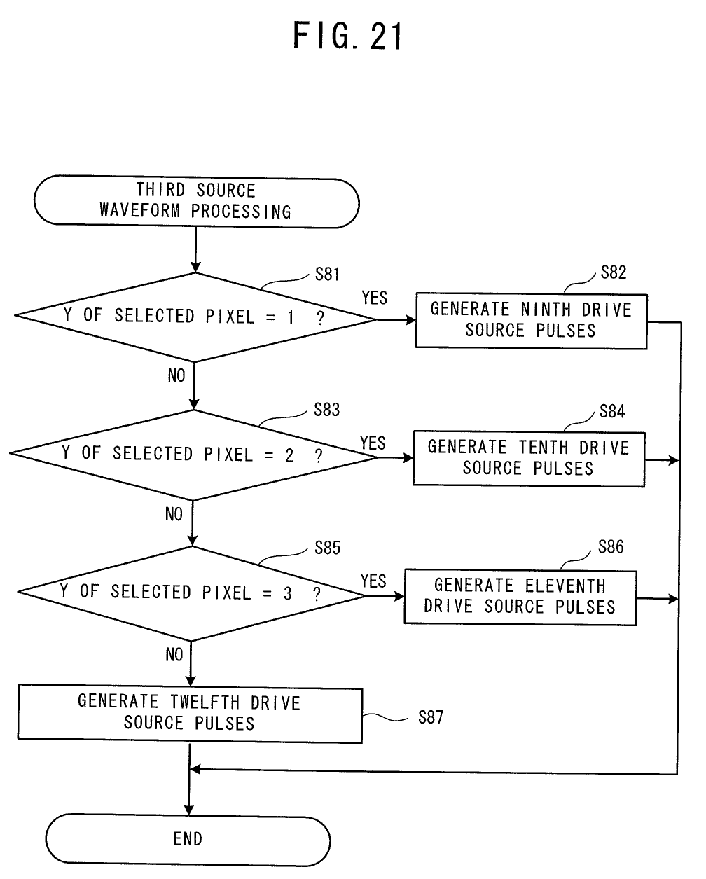

As shown in FIG. 21, in the third source waveform processing, first, a determination is made as to whether the tone level Y of the selected pixel after redrawing is white (1) (S81). If the tone level is white (1) (YES at S81), ninth drive source pulses for redrawing from dark gray to white, are generated (S82), and the third source waveform processing ends. If the tone level Y after redrawing is not white (1) (NO at S81), a determination is made as to whether the tone level Y after redrawing is light gray (2) (S83). If the tone level is light gray (2) (YES at S83), tenth drive source pulses for redrawing from dark gray to light gray, are generated (S84), and the third source waveform processing ends. If the tone level Y after redrawing is not light gray (2) (NO at S83), a determination is made as to whether the tone level Y after redrawing is dark gray (3) (S85). If the tone level is dark gray (3) (YES at S85), eleventh drive source pulses for redrawing from dark gray to dark gray, are generated (S86), and the third source waveform processing ends. If the tone level Y after redrawing is not dark gray (3) (NO at S85), twelfth drive source pulses for redrawing from dark gray to black, are generated (S87), and the third source waveform processing ends. When the third source waveform processing ends, the difference processing shown in FIG. 18 ends, and the processing returns to the source pulse generation processing shown in FIG. 17.

Next, returning to the explanation of the difference processing shown in FIG. 18, if it is determined that the tone level X of the selected pixel before redrawing is not white (1), not light gray (2), and not dark gray (3) (NO at S51, NO at S53, NO at S55), the tone level X of the selected pixel before redrawing is black (4). Fourth source waveform processing is then performed (S57).

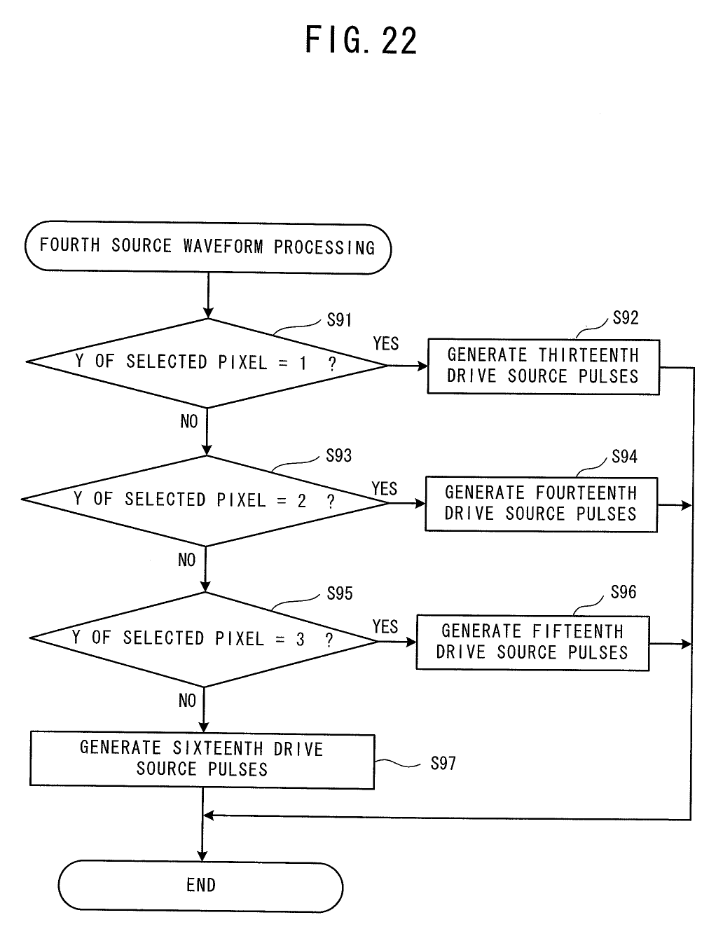

As shown in FIG. 22, in the fourth source waveform processing, first, a determination is made as to whether the tone level Y of the selected pixel after redrawing is white (1) (S91). If the tone level is white (1) (YES at S91), thirteenth drive source pulses for redrawing from black to white, are generated (S92), and the fourth source waveform processing ends. If the tone level Y after redrawing is not white (1) (NO at S91), a determination is made as to whether the tone level Y after redrawing is light gray (2) (S93). If the tone level is light gray (2) (YES at S93), fourteenth drive source pulses for redrawing from black to light gray, are generated (S94), and the fourth source waveform processing ends. If the tone level Y after redrawing is not light gray (2) (NO at S93), a determination is made as to whether the tone level Y after redrawing is dark gray (3) (S95). If the tone level is dark gray (3) (YES at S95), fifteenth drive source pulses for redrawing from black to dark gray, are generated (S96), and the fourth source waveform processing ends. If the tone level Y after redrawing is not dark gray (3) (NO at S95), sixteenth drive source pulses for redrawing from dark gray to black, are generated (S97), and the fourth source waveform processing ends. When the fourth source waveform processing ends, the difference processing shown in FIG. 18 ends, and the processing returns to the source pulse generation processing shown in FIG. 17.

Next, the explanation will return to the source pulse generation processing shown in FIG. 17. If the drive source pulses have been generated for the selected pixel in the first area in the difference processing (S45), 1 is added to the value of the counter G (S46). 1 is also added to the value of the counter G (S46), if it has been determined that the selected pixel is a pixel in the second area (NO at S44). Next, a determination is made as to whether the value of the counter G is not greater than the number N of the gate lines 71 (S47). If the value of the counter G is not greater than N (NO at S47), among the pixels that are associated with the source line 73 indicated by the counter S, a pixel still remains for which the processing of generating the drive source pulses has not been performed, so the processing returns to S43.

If the value of the counter G is greater than N (YES at S47), the processing that generates the source drive pulses has been completed for the source line 73 that is indicated by the counter S, so 1 is added to the value of the counter S (S48). Then a determination is made as to whether the value of the counter S is not greater than the number M of the source lines 73 (S49). If the value of the counter S is not greater than M (NO at S49), then a source line 73 remains for which the drive source pulses have not been generated, so the processing returns to S41. If the value of the counter S is greater than M (YES at S49), the drive source pulses have been generated for all of the source lines 73, so the source pulse generation processing ends, and the processing returns to the driver control processing. As shown in FIG. 15, when the source pulse generation processing (S6) ends, waveform data are transmitted to the drivers (S7). Specifically, waveform data for the gate pulses that are generated in the gate pulse generation processing at S5 is transmitted to the gate driver 8. In addition, waveform data for the source pulses that are generated in the source pulse generation processing at S6 is transmitted to the source driver 9. Then, the driver control processing ends.

As explained above, in the electrophoretic display device 1 according to the present embodiment, the different forms of redrawing control for the first area and the second area can be implemented by simple processing that merely varies the cycles of the applied gate pulses and the number of times that the voltages are applied. Furthermore, the shaking source pulses that are used to apply the shaking pulses to the pixel electrodes 22 in the first area can be used to change the tone level of the pixels in the second area. It is therefore not necessary to generate new source pulses that are used to apply the voltages to the pixel electrodes 22 in the second area, so the control is simple, and the electrophoretic display device 1 can be driven with low power consumption. Moreover, the voltages of the second gate pulses are constantly OFF voltages after the predetermined pulses have been applied in accordance with the amount of change in the tone levels, so the power that is consumed by the gate driver 8 can be reduced.

Various modifications are obviously permissible in the embodiment described in detail above.

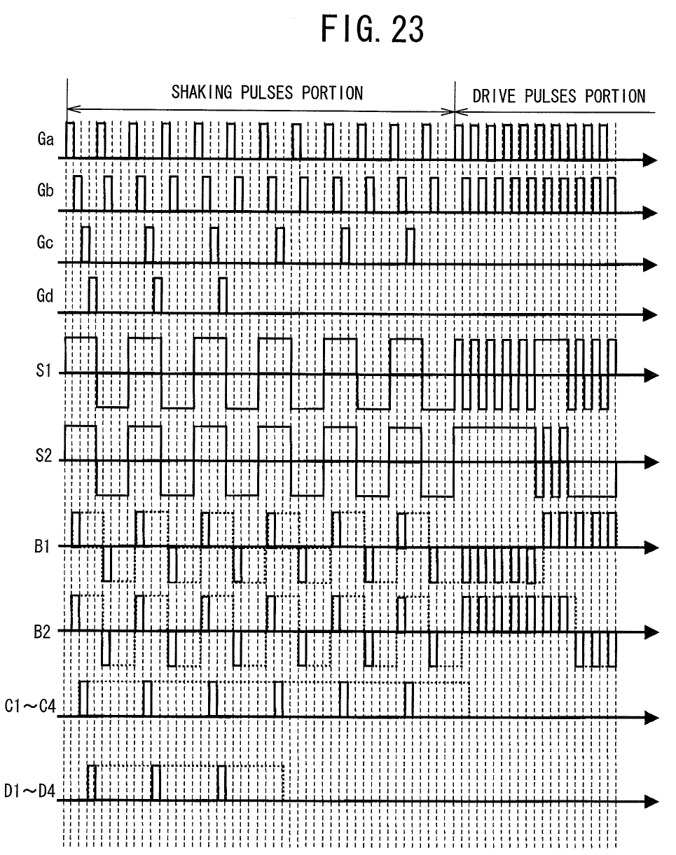

First, an electrophoretic display device that is a modified embodiment will be explained with reference to FIG. 23. The electrophoretic display device according to the modified embodiment differs from the electrophoretic display device 1 only in that the waveforms in the drive pulses portion of the first pulses are different. The shaking pulses portion of the first pulses, the second pulses, the mechanical configuration, and the like are the same as in the electrophoretic display device 1. In the electrophoretic display device according to the modified embodiment, when the drive pulses (the waveforms shown in the drive pulses portion of B1 and B2) of the first pulses are applied, the cycles for the first gate pulses (the waveforms Ga and Gb) are made shorter than the cycles during the application of the shaking pulses. During the application of the shaking pulses, the length of time that is required for one cycle is computed by multiplying the number of the gate lines 71 by the unit time period P during which the voltage is applied. However, when the drive pulses are applied, the voltages of the second gate pulses are constantly OFF voltages. Therefore, in the modified embodiment, one cycle is defined as P times the number of the gate lines 71, among all of the gate lines 71, to which the first pulses are applied. Accordingly, the image may be redrawn without wasting power, and the time that is required for the image redrawing processing may also be shortened.

Furthermore, in the above embodiment, in a case where a specific area that corresponds to a gate line 71 is the second area, and the amount of change in the tone level of the specific area is zero, the second gate pulses (±0) are generated (refer to FIG. 16, S33). Specifically, the voltages of the second gate pulses (±0) are constantly OFF voltages. It is therefore possible to shorten the cycles for the gate pulses that are applied to the other gate lines 71, thus making it possible to implement more precise control.

Furthermore, in the present embodiment, it is determined whether the specific area is one of a first area and a second area based on a determination of whether a menu is to be displayed after the image is redrawn, a determination of whether the specific area is an area in which a menu display image is to be formed, and the like. However, the present disclosure is not limited to this example. For example, even in a case other than when a menu is to be displayed, a second area may be provided as necessary, such as in a case where a title screen is to be displayed, a case where a new display screen is to be displayed such that the new display screen overlaps a portion of an old display screen, and the like. The present disclosure may also be configured such that a user may designate whether the specific area is one of a first area and a second area. Further, in a case where a normal mode and a power-saving mode are provided, and the power-saving mode is set, a greater number of specific areas may be designated as second areas than when the normal mode is set.

In the present embodiment, the black charged particles 50 and the white charged particles 60 are used to create four tone levels, but any combination of colors may be employed. It is also possible to use black charged particles that are dispersed in a white dispersion medium, for example. Further, although the IPD 15 that controls the gate driver 8 and the source driver 9 is provided in the controller portion 6 in the present embodiment, the present disclosure is not limited to an example using an IPD, and a processing device such as a CPU or the like may also be used. Also, in the present embodiment, the common electrode 12 is provided in the display substrate 10, and the pixel electrodes 22 are provided in the rear substrate 20. However, an electrophoretic display panel control device that includes an electrode and a voltage application device may be separated from the display panel that is incapable of redrawing the image by itself.

According to the present disclosure, a source pulse generation device may generate the source pulse for each of the pixels in accordance with the relationship between the tone levels before and after redrawing. An area determination device may determine whether the specific area, which is an area that includes pixels corresponding to the gate line 71, is the first area or the second area. Further, a gate pulse generation device may generate the first gate pulse having a predetermined waveform, and the second gate pulse having a waveform different from the waveform of the first gate pulse. A gate pulse application device may apply the first gate pulse to a gate line 71 that corresponds to the first area and applies the second gate pulse to a gate line 71 that corresponds to the second area. Accordingly, by using the first gate pulses and the second gate pulses, it may be possible to provide the second area, where the tone levels of the pixels may be changed, without performing complicated processing. The processing speed for redrawing the image may thus be increased.

Further, according to the present disclosure, the source pulse generation device may generate the shaking source pulse to be used to apply the shaking pulse, which releases the charged particles 50 and 60 from the static state, to the pixel electrode 22. The source pulse generation device may also generate the drive source pulse to be used to apply the drive pulse, which adjusts the tone level of each of the pixels in accordance with the relationship between the tone levels before and after redrawing, to the pixel electrode 22. The waveform of the first gate pulse and the wave form of the second gate pulse may be different in a portion which corresponds to a shaking period in which the shaking pulse is applied to the pixel electrode 22. Thus different forms of redrawing control may be implemented in the first area and the second area by simple processing that merely varies the waveform of the gate pulse by using the same shaking pulse.

Also according to the present disclosure, the gate pulse generation device may generate the second gate pulse that does not apply a voltage to set the thin film transistor 75 to an on state after the shaking pulses are applied to the pixel electrodes 22. Accordingly, the power consumption of the gate driver 8 may be reduced.

Additionally, according to the present disclosure, the cycle of the waveform of the first gate pulse after the shaking period may be shorter than the cycle of the waveform in the shaking period. Accordingly, it may be possible to implement precise control without wasting power as compared with a case where the cycle of the waveform of the first gate pulse after the shaking period is longer than the cycle of the waveform in the shaking period.

Furthermore, according to the present disclosure, the cycle of the waveform of the first gate pulse and the cycle of the waveform of the second gate pulse may be different in the shaking period. Thus, different forms of redrawing control may be implemented in the first area and the second area by simple processing that merely varies the cycle of the gate pulse by using the same shaking pulse.

Further, according to the present disclosure, the waveform of the second gate pulse may be a waveform to apply voltage to set the thin film transistor 75 to the on state when the source pulse having a specific polarity is applied. Accordingly, a voltage that is one of a positive polarity and a negative polarity is applied to the pixel electrode 22. Thus, it may be possible to perform redrawing of the image in a second area efficiently, using less power, as compared with a case where voltages of both polarities are applied to the pixel electrode 22.

Also according to the present disclosure, the gate pulse generation device may generate a number of the second gate pulses to apply a voltage that is different in accordance with an amount of change in the tone levels of the pixels in the second area before and after redrawing. In addition, the gate pulse application device may apply the number of the second gate pulses, in accordance with the amount of change in the tone levels, to the pixels in the second area. Thus, the tone level of the pixels in the second area may be changed even if the magnitude of the applied voltage and the period in which the voltage is applied are not changed.

The electrophoretic display control device and the electrophoretic display device according to the present disclosure may be used in a wide variety of electronic devices that are each equipped with a display portion. Examples of the electronic devices include electronic paper and the like. The electronic paper includes a main unit and a display unit to display an image. The main unit is configured as a rewritable sheet that is thin like paper and has an image display quality with visibility that is close to visibility of paper.

The electrophoretic display device may also be used in a display portion of a device with a built-in operation portion, such as a mobile computer. In this sort of case, a desired image may be displayed in the display portion based on a signal of content that represents an operation of the operation portion. In addition, the electrophoretic display device may be used as a display portion that is provided in an electronic device such as a mobile telephone, an electronic book, a television, a calculator, or the like.

While the invention has been described in connection with various exemplary structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. An electrophoretic display control device that controls redrawing of an image of an electrophoretic display panel, the electrophoretic display panel including a transparent display substrate, a rear substrate disposed to face the display substrate, a dispersion medium filled in a space between the display substrate and the rear substrate and having charged particles dispersed therein, pixel electrodes disposed in a matrix pattern on the rear substrate corresponding to pixels, a thin film transistor connected to each of the pixel electrodes, a gate line connected to the thin film transistor, and a source line connected to the thin film transistor, and the electrophoretic display control device comprising:
a source pulse generation device that generates a source pulse for each of the pixels, the source pulse being a pulse applied to the source line in accordance with a relationship between tone levels of each of the pixels before and after redrawing;
an area determination device that determines whether a specific area is a first area or a second area, the specific area being an area including pixels corresponding to the gate line, the first area being an area to which a first gate pulse is to be applied, the second area being an area to which a second gate pulse is to be applied, the first gate pulse being a pulse to be applied to the gate line and having a predetermined first waveform, and the second gate pulse to be applied to the gate line and having a second waveform different from the first waveform;
a gate pulse generation device that generates the first gate pulse or the second gate pulse in accordance with the specific area determined as the first area or the second area by the area determination device;
a source pulse application device that applies the source pulse generated by the source pulse generation device to the source line; and
a gate pulse application device that applies the first gate pulse or the second gate pulse generated by the gate pulse generation device to the gate line.

2. The electrophoretic display control device according to claim 1, wherein:
the source pulse generation device generates a shaking source pulse to be used to apply a shaking pulse and a drive source pulse to be used to apply a drive pulse, the shaking pulse including pulses having alternating polarity and releasing the charged particles from a static state, and the drive pulse being a pulse adjusting the tone level of each of the pixels in accordance with the relationship between the tone levels before and after redrawing; and
the first waveform of the first gate pulse and the second waveform of the second gate pulse are different in a portion which corresponds to a shaking period in which the shaking pulse is applied.

3. The electrophoretic display control device according to claim 2, wherein a cycle of the first waveform of the first gate pulse and a cycle of the second waveform of the second gate pulse are different in the shaking period.

4. The electrophoretic display control device according to claim 1, wherein:
the source pulse generation device generates a shaking source pulse to be used to apply a shaking pulse and a drive source pulse to be used to apply a drive pulse, the shaking pulse including pulses having alternating polarity and releasing the charged particles from a static state, and the drive pulse being a pulse adjusting the tone level of each of the pixels in accordance with the relationship between the tone levels before and after redrawing; and
the gate pulse generation device generates the second gate pulse to apply a voltage to set the thin film transistor to an off state after a shaking period in which the shaking pulses are applied.

5. The electrophoretic display control device according to claim 4, wherein a cycle of the first waveform of the first gate pulse after the shaking period is shorter than a cycle of the first waveform in the shaking period.

6. The electrophoretic display control device according to claim 1, wherein the second waveform of the second gate pulse is a waveform to apply a voltage to set the thin film transistor to an on state when the source pulse having a specific polarity is applied.

7. The electrophoretic display control device according to claim 1, wherein:
the gate pulse generation device generates a number of the second gate pulses to apply a voltage, the number being different in accordance with an amount of change in the tone levels of the pixels in the second area before and after redrawing; and
the gate pulse application device applies the number of the second gate pulses in accordance with the amount of change in the tone levels of the pixels in the second area before and after redrawing.

8. An electrophoretic display device comprising:
an electrophoretic display panel that includes:
a transparent display substrate;
a rear substrate disposed to face the display substrate;
a dispersion medium filled in a space between the display substrate and the rear substrate and having charged particles dispersed therein;
pixel electrodes disposed in a matrix pattern on the rear substrate corresponding to pixels;
a thin film transistor connected to each of the pixel electrodes;
a gate line connected to the thin film transistor; and
a source line connected to the thin film transistor, and
an electrophoretic display control device that includes:
a source pulse generation device that generates a source pulse for each of the pixels, the source pulse being a pulse applied to the source line in accordance with a relationship between tone levels of each of the pixels before and after redrawing;
an area determination device that determines whether a specific area is a first area or a second area, the specific area being an area including pixels corresponding to the gate line, the first area being an area to which a first gate pulse is to be applied, the second area being an area to which a second gate pulse is to be applied, the first gate pulse being a pulse to be applied to the gate line and having a predetermined first waveform, and the second gate pulse to be applied to the gate line and having a second waveform different from the first waveform;
a gate pulse generation device that generates the first gate pulse or the second gate pulse in accordance with the specific area determined as the first area or the second area by the area determination device;
a source pulse application device that applies the source pulse generated by the source pulse generation device to the source line; and
a gate pulse application device that applies the first gate pulse or the second gate pulse generated by the gate pulse generation device to the gate line.

9. The electrophoretic display device according to claim 8, wherein:
the source pulse generation device generates a shaking source pulse to be used to apply a shaking pulse and a drive source pulse to be used to apply a drive pulse, the shaking pulse including pulses having alternating polarity and releasing the charged particles from a static state, and the drive pulse being a pulse adjusting the tone level of each of the pixels in accordance with the relationship between the tone levels before and after redrawing; and
the first waveform of the first gate pulse and the second waveform of the second gate pulse are different in a portion which corresponds to a shaking period in which the shaking pulse is applied.

10. The electrophoretic display device according to claim 9, wherein a cycle of the first waveform of the first gate pulse and a cycle of the second waveform of the second gate pulse are different in the shaking period.

11. The electrophoretic display device according to claim 8, wherein:
the source pulse generation device generates a shaking source pulse to be used to apply a shaking pulse and a drive source pulse to be used to apply a drive pulse, the shaking pulse including pulses having alternating polarity and releasing the charged particles from a static state, and the drive pulse being a pulse adjusting the tone level of each of the pixels in accordance with the relationship between the tone levels before and after redrawing; and
the gate pulse generation device generates the second gate pulse to apply a voltage to set the thin film transistor to an off state after a shaking period in which the shaking pulses are applied.

12. The electrophoretic display device according to claim 11, wherein a cycle of the first waveform of the first gate pulse after the shaking period is shorter than a cycle of the first waveform in the shaking period.

13. The electrophoretic display device according to claim 8, wherein the second waveform of the second gate pulse is a waveform to apply a voltage to set the thin film transistor to an on state when the source pulse having a specific polarity is applied.

14. The electrophoretic display device according to claim 8, wherein:
the gate pulse generation device generates a number of the second gate pulses to apply a voltage, the number being different in accordance with an amount of change in the tone levels of the pixels in the second area before and after redrawing; and
the gate pulse application device applies the number of the second gate pulses in accordance with the amount of change in the tone levels of the pixels in the second area before and after redrawing.

15. A computer program product comprising a computer-readable medium storing computer readable instructions for controlling redrawing of an image of an electrophoretic display panel, the electrophoretic display panel including a transparent display substrate, a rear substrate disposed to face the display substrate, a dispersion medium filled in a space between the display substrate and the rear substrate and having charged particles dispersed therein, pixel electrodes disposed in a matrix pattern on the rear substrate corresponding to pixels, a thin film transistor connected to each of the pixel electrodes, a gate line connected to the thin film transistor, and a source line connected to the thin film transistor, wherein execution of the computer readable instructions causes a controller to perform the steps of:
generating a source pulse for each of the pixels, the source pulse being a pulse applied to the source line in accordance with a relationship between tone levels of each of the pixels before and after redrawing;
determining whether a specific area is a first area or a second area, the specific area being an area including pixels corresponding to the gate line, the first area being an area to which a first gate pulse is to be applied, the second area being an area to which a second gate pulse is to be applied, the first gate pulse being a pulse to be applied to the gate line and having a predetermined first waveform, and the second gate pulse to be applied to the gate line and having a second waveform different from the first waveform;
generating the first gate pulse or the second gate pulse in accordance with the specific area determined as the first area or the second area;
applying the generated source pulse to the source line; and
applying the generated first gate pulse or the generated second gate pulse to the gate line.

16. The computer program product according to claim 15, wherein:
the step of generating the source pulse generates a shaking source pulse to be used to apply a shaking pulse and a drive source pulse to be used to apply a drive pulse, the shaking pulse including pulses having alternating polarity and releasing the charged particles from a static state, and the drive pulse being a pulse adjusting the tone level of each of the pixels in accordance with the relationship between the tone levels before and after redrawing; and
the first waveform of the first gate pulse and the second waveform of the second gate pulse are different in a portion which corresponds to a shaking period in which the shaking pulse is applied.

17. The computer program product according to claim 16, wherein a cycle of the first waveform of the first gate pulse and a cycle of the second waveform of the second gate pulse are different in the shaking period.

18. The computer program product according to claim 15, wherein:
the step of generating the source pulse generates a shaking source pulse to be used to apply a shaking pulse and a drive source pulse to be used to apply a drive pulse, the shaking pulse including pulses having alternating polarity and releasing the charged particles from a static state, and the drive pulse being a pulse adjusting the tone level of each of the pixels in accordance with the relationship between the tone levels before and after redrawing; and
the step of generating the first gate pulse or the second gate pulse generates the second gate pulse to apply a voltage to set the thin film transistor to an off state after a shaking period in which the shaking pulses are applied.

19. The computer program product according to claim 18, wherein a cycle of the first waveform of the first gate pulse after the shaking period is shorter than a cycle of the first waveform in the shaking period.

20. The computer program product according to claim 15, wherein the second waveform of the second gate pulse is a waveform to apply a voltage to set the thin film transistor to an on state when the source pulse having a specific polarity is applied.

21. The computer program product according to claim 15, wherein:
the step of generating the first gate pulse or the second gate pulse generates a number of the second gate pulses to apply a voltage, the number being different in accordance with an amount of change in the tone levels of the pixels in the second area before and after redrawing; and
the step of applying the generated first gate pulse or the generated second gate pulse applies the number of the second gate pulses in accordance with the amount of change in the tone levels of the pixels in the second area before and after redrawing.
